(19) United States
(12) Patent Application Publication
(10) Pub. No.: US 2013/0253910 A1
(43) Pub. Date: Sep. 26, 2013

(54) Systems and Methods for Analyzing Digital Communications

(71) Applicant: SENTENTIA, LLC, Fishers, IN (US)

(72) Inventors: Harris Turner, Fishers, IN (US); Johan Bollen, Bloomington, IN (US)

(73) Assignee: Sententia, LLC, Fishers, IN (US)

(21) Appl. No.: 13/849,505

(22) Filed: Mar. 23, 2013

Related U.S. Application Data
(60) Provisional application No. 61/615,056, filed on Mar. 23, 2012.
(60) Provisional application No. 61/729,193, filed on Nov. 21, 2012.

(51) Int. Cl. G06F 17/21

(52) U.S. Cl. CPC G06F 17/21
USPC 704/9

(57) ABSTRACT

Systems and methods are provided for analyzing text within digital document. In some cases the analysis can include receiving and/or generating a digital document with processing circuitry and determining a distribution of each of a plurality of document terms based on occurrences of the document terms within a text sample and occurrences of sample terms within the text sample. Processing circuitry may be further used to determine a distribution characteristic for each of the plurality of document terms. The distribution characteristic for each document term can provide a measure of a characteristic of each respective document term's distribution. In some cases a characterization is provided of the text in the digital document with the processing circuitry based on the distribution characteristic of at least one of the plurality of document terms.

### CROSS-REFERENCES

This application claims the benefit of U.S. Provisional Patent Application No. 61/615,056, filed Mar. 23, 2012, and U.S. Provisional Patent Application No. 61/729,193, filed Nov. 21, 2012, the contents each of which are hereby incorporated by reference in their respective entireties.

### FIELD

This disclosure generally relates to digital communications and digital documents, and more particularly relates to systems and methods for analyzing, determining, and/or reviewing the same.

### BACKGROUND

When communicating orally, we send and receive vocal inflections that provide contextual and emotive “cues” to our state of mind or point of view as the speaker. When face-to-face, we may also add facial and other visual cues. We learn from an early age how to interpret these oral and visual nuances to determine the meaning, intent, and context of communications. These types of cues can vary among different cultures and languages.

During the composition of written communications, an author (e.g., the person writing, composing, creating, and/or responsible for the content of the communication) often mentally “hears” his/her own cues. For example, the author knows exactly what he/she intends and how they are saying it, but the written language rarely translates these cues directly into the message. This leads to subjective nuance that can be easily misinterpreted and, in fact, often is.

Further, the recipient of a written communication does not hear the intended cues and as a result, may often interpret the message in a letter, email, text message, or other digital communication in terms of their own point of view or state of mind, and not that of the author. In fact, the author may have an entirely different intent than that to which the recipient attributes the message, leading to incorrect assumptions. For example, the recipient of the message may ask questions such as “Is this person angry with me?”; “Why did he/she say it like that?”; “What does he mean by ‘reasonable’?”; and/or “Is she making a suggestion or issuing a directive?”

With constantly evolving methods of digital communication, along with the accompanying limitations of technology and devices, there is a large opportunity for digital miscommunication. Some factors that may lead to such miscommunications include tiny keyboards on smart phones, a 140 character limit for some text messages, and time limitations in answering the sheer volume of email received in the workplace.

One of the challenges of the current environment is that an inordinate amount of time is spent attempting to interpret the meaning of these messages, resulting in huge inefficiencies. This can occur in both the workplace and in personal communication. Of concern are instances in which an incorrect course is charted and/or counterproductive actions are taken as a result of misinterpreted communications.

While it is difficult to measure the cost of this lost productivity, almost everyone seems to have experienced multiple instances of digital communications with unclear intentions, contexts, multiple ambiguities, and the like. This results in a large amount of time and effort expended to understand the true intent of the author. In early research of some of the ideas described further herein, 100% of those involved could recount numerous instances of miscommunication where this challenge had resulted in a significant and serious loss of productivity.

Emerging technologies are utilizing associative databases of words and phrases, combined with social media “chatter” to analyze mood or preference. For instance, in the burgeoning sentiment analysis field, companies are tasked with determining whether a theory, service, or product is viewed as positive, negative, or neutral. A hotel group may launch a new product and hires a sentiment analysis company to determine whether the product is generally liked (positive), disliked (negative), or generates no opinion (neutral). The sentiment analysis company aggregates millions of Twitter tweets, Facebook likes, and various blogs, searching for any word or phrase referencing the new product. These product references are then compared to existing databases of words that are, by definition, positive, negative, or neutral. This approach, while successful and worthwhile, is limited in its applicability, as it pertains solely to how products, services, people, brands, places, etc., are perceived by the online community.

### SUMMARY

Embodiments of the invention provide systems, devices, and/or methods for analyzing digital communications in one or more contexts. Some embodiments may provide the capability to analyze the content of a digital document that may be generated, transmitted, and/or received as part of a digital communication and/or using an electronic communications system. Some embodiments may provide analyzing of digital document text or content independently of actual transmission between two parties. In some cases types of digital documents that may be analyzed include, but are not limited to, text files, word processing documents, email correspondence, text messages, multimedia messages, instant messages, web page files, and other types of digital computer files containing digital text or message content.

Some embodiments of the invention provide a method for analyzing a digital document. The method includes receiving and/or generating a digital document with processing circuitry. The digital document includes or contains a text that has multiple document terms. The method further includes using the processing circuitry to determine a distribution of each of the document terms. The distribution is based on occurrences of the document terms within a text sample and occurrences of sample terms within the same text sample. The method also includes determining, with the processing circuitry, a distribution characteristic for each of the document terms. The distribution characteristic for each document term provides a measure of a characteristic of that document term's distribution. The method can also include using the processing circuitry to provide a characterization of the text in the digital document based on the distribution dispersion of at least one of the document terms.

Some embodiments of the invention include a system for analyzing digital documents. In some cases, the system includes an input module, an output module, and processing circuitry coupled to the input module and the output module. The processing circuitry is configured to receive a digital document from the input module and/or generate a digital document. The digital document includes a text having multiple document terms. The processing circuitry is further configured to determine a distribution of each of the document terms based on occurrences of the document terms within a text sample and occurrences of sample terms within the text sample. The processing circuitry is also configured to determine a distribution characteristic for each of the document terms. The distribution characteristic for each document term provides a measure of a characteristic of each document term's distribution. The processing circuitry can also be configured to provide a characterization of the text in the digital document based on the distribution characteristic of at least one of the document terms.

Some embodiments of the invention provide an electronic communications system for analyzing digital documents. The system includes at least an input device, processing circuitry coupled to the input device, and an output device coupled to the processing circuitry. The input device is configured to receive text of a digital document from an end user of the system. The output device is configured to transmit and/or display an output from the processing circuitry, and in some embodiments may comprise an electronic display and/or a communications port. In some cases the text of the digital document comprises multiple document terms. According to some embodiments, the processing circuitry is configured to receive the text of the digital document from the input device, analyze the text, and provide a characterization of the text in the digital document to the output device. In some cases the text analysis determines one or more text characterization factors corresponding to respective aspects of the text in the digital document and the processing circuitry provides the characterization of the text based on the one or more text characterization factors. The one or more text characterization factors can include a first factor corresponding to a first aspect of the digital document text. In some cases the first aspect includes ambiguity and/or clarity of the text in the digital document.

Some embodiments may optionally provide none, some, or all of the following advantages, features, and/or optional characteristics, though others not listed here may also be provided.

According to some embodiments, processing circuitry may determine the distribution of multiple document terms by determining a probability distribution, a frequency distribution, a co-occurrence distribution and/or a co-location distribution for each of the document terms with respect to the sample terms within the text sample. In some cases, the distribution characteristic of each document term comprises a dispersion metric and/or an inequality index determined based on the document term's distribution. According to some embodiments a distribution characteristic (e.g., such as a distribution dispersion or an inequality index) may be determined according to occurrences of the sample terms within the sample text corresponding to each of the document terms (e.g., co-located and/or co-occurring terms). In some cases a distribution characteristic, an inequality index, and/or other measure of variance in the distribution of one or more document terms can be determined according to an estimated exponent of rank-ordered distribution terms, a y-intersect of an exponential function fitted to rank-ordered distribution terms, a Gini coefficient of a distribution of each document term, an entropy of a distribution of each document term, and/or one of these or another measure of the distribution calculated for a particular sub-sample of terms.

According to some embodiments, the characterization of the text in the digital document is based on one or more text characterization factors. In such cases, processing circuitry can be configured to determine one or more of the factors, which correspond to respective aspects of the text of the digital document. Some embodiments include computing a first factor based on a distribution characteristic of at least one of the document terms. In some cases the first factor can include an ambiguity score and a corresponding first aspect of the text includes a state of ambiguity and/or clarity of the text in the digital document. According to some embodiments, one aspect of the text includes compliance with a predetermined criteria, and such an embodiment can further include determining a first factor by comparing document terms to a word list. In some cases document terms may be compared to one or more word lists alone or in combination with one or more logical outcomes. According to some embodiments an aspect of the text comprises part of speech. Determining a corresponding factor in this example can include determining a part of speech tag for each of the document terms.

According to some embodiments, providing a characterization of the text in a digital document includes providing an indication as to whether the text in the digital document satisfies a predetermined compliance criteria.

In some cases a system can include processing circuitry that further includes at least one processor and at least one non-transitory computer-readable medium storing instructions for configuring the at least one processor to perform a number of functions or tasks. In some cases the instructions configure the processor to receive and/or generate the digital document, determine the distribution for each of the plurality of document terms, determine the distribution characteristic for each of the plurality of document terms, and provide the characterization of the text in the digital document. According to some embodiments, processing circuitry may analyze portions of the text of a digital document during composition of the text by the end user. In some cases the processing circuitry is configured to provide corresponding characterizations of the portions of the text to the output device during composition of the text. According to some embodiments, processing circuitry may analyze portions of the text of a digital document during and/or after composition of the text by the end user. In such a case, the processing circuitry can be configured to provide the characterization of the text to the output device only after composition of the text is completed by the end user. According to some embodiments an electronic communications system includes an output device that includes an electronic display. The processing circuitry of the device can be configured to provide the characterization of the text to the end user by changing a format of one or more portions of the text or the digital document and/or generating a text notification for viewing by the end user on the electronic display.

According to some embodiments, systems and/or methods are provided to analyze one or more components or aspects of the lexicon, in some cases as it is generated and/or received as part of a digital document. In some cases embodiments provide an analysis of one or more message or text components or aspects that are much broader and more complex than aspects of the lexicon that have been previously analyzed. As just one example, in some cases systems and/or methods are provided to analyze an aspect of a digital text that includes the clarity of the text and its underlying components. As used herein the term clarity is used to describe the extent to which there is an absence of ambiguity in a text. In some cases clarity encompasses a state of text or communication that is more or less objective and direct, and sufficiently free of ambiguity, subjectivity, nuance, cliché or colloquialisms, at least the extent that such aspects may hinder a person's understanding of the text.

Some embodiments of the invention relate to devices, systems and methods for reviewing components or aspects of digital communications such as context, implied intent, clarity, ambiguity, and the like. In some cases embodiments may assist an author and/or a recipient of a digital message or other text (e.g., within a digital document) identify and/or reduce or eliminate ambiguity in the text or confusion of the author's intent for the message. Accordingly, some embodiments may reduce the time, effort, and/or emotion necessary to determine the perceived/implied intent of a message or other text within a digital document.

According to some embodiments, a method for reviewing a digital document is provided. The method can include analyzing the text of the document and providing feedback to an author about a perceived intent and/or meaning of the analyzed text. The method may also include providing suggested alternative text or phrases to the end user and/or modifying the text based on an author's selection of suggested text or manual entry of alternate text.

Some embodiments can provide a system for reviewing a digital document that includes processing circuitry electrically coupled with an input device and an output device. Some examples of processing circuitry include microprocessors, memory, and the like programmed with software instructions that cause the processing circuitry to carry out the desired functionality. The system's processing circuitry can be configured to provide a method for reviewing a digital document. The method includes analyzing the text of the document and providing feedback to a user about a perceived intent and/or meaning of the analyzed text. The method may also include providing suggested alternative text or phrases to the user and modifying the text based on a user's selection of suggested text or manual entry of alternate text. In some cases the feedback can include a characterization of the text based on one or more text characterization factors. As just one possible example, one text characterization factor can include a measure or computation of ambiguity that corresponds to a first aspect/component of the text that includes ambiguity and/or clarity of the text in the digital document.

In some cases, a system can include an analysis engine or plug-in for one or more digital message/text production software applications, such as word processing, e-mail, text, and related applications. Possible examples include Microsoft Word, Outlook, Salesforce, Google Mail, and various applications for smart phones, among others. In some cases, an embodiment may identify subjective words, phrases, fonts, punctuation, contextual cues, and/or other factors that may be easily misinterpreted and/or may increase the ambiguity of a text. A system may in some cases proactively provide feedback when elements or terms of the message may trigger confusion about or misinterpretation of the purpose and/or point of view of the author/sender. In some cases a system may provide suggestions (e.g., words, phrases, fonts, or other digital elements) to objectify a message by clarifying the intent and context of the communication.

According to some embodiments, a system and/or method may provide a plug-in for one or more engines that examine messages in an effort to determine the likes and dislikes of individuals. Possible examples of such like/dislike engines include Elektron Analytics, Attensity, Netbase, Anderson Analytics, and others that exam digital communications in an attempt to determine the positive, negative, or neutral sentiment of the messages. In some cases, an embodiment may identify subjective words, phrases, fonts, punctuation, contextual cues, and/or other factors that may be easily misinterpreted. A system may in some cases proactively provide feedback when elements of the message are likely to trigger confusion or misinterpretation about the purpose and/or point of view of the sender. In some cases a system may provide suggestions (e.g., words, phrases, fonts, or other digital elements) to objectify a message by clarifying the intent and context of the communication.

These and various other features and advantages will be apparent from a reading of the following detailed description.

### BRIEF DESCRIPTION OF THE DRAWINGS

The following drawings illustrate particular embodiments of the invention and therefore do not limit the scope of the invention. The drawings are not to scale (unless so stated) and are intended for use in conjunction with the explanations in the following detailed description. Embodiments of the invention will hereinafter be described in conjunction with the appended drawings, wherein like numerals denote like elements.

FIG. 1 is flow diagram illustrating two processes for reviewing digital communications according to some embodiments.

FIG. 2 is a schematic diagram of a system for reviewing digital communications according to some embodiments.

FIG. 3 is a depiction of an email application on a personal computer according to some embodiments.

FIG. 4 is a depiction of a word processing application according to some embodiments.

FIG. 5 is a depiction of an Internet-based email application according to some embodiments.

FIGS. 6A and 6B are depictions of a text messaging application on a smart phone according to some embodiments.

FIG. 7 is a depiction of an email application on a smart phone according to some embodiments.

FIGS. 8A-8Q are depictions of a message composition window as part of an email application according to some embodiments.

FIG. 9 is a depiction of a compliance control interface as part of the email application illustrated in FIGS. 8A-8Q according to some embodiments.

FIGS. 10A and 10B are depictions of a communications reports interface as part of the email application illustrated in FIGS. 8A-8Q according to some embodiments.

FIGS. 11A-11C are depictions of a message reading pane as part of the email application illustrated in FIGS. 8A-8Q according to some embodiments.

FIGS. 11D-11E are depictions of a reply composition window as part of the email application illustrated in FIGS. 8A-8Q according to some embodiments.

FIG. 12 shows a hypothetical illustration of collocation distributions for two terms, namely “chair” (unambiguous) and “thing” (ambiguous) according to some embodiments.

FIG. 13 illustrates aspects of the calculation of a measure of inequality according to some embodiments.

FIG. 14 illustrates one possible example of a general architecture for a system for analyzing clarity and ambiguity in digital communications according to some embodiments.

FIG. 15 illustrates one possible case example, among many, of a unigram to bigram frequency distribution analysis according to some embodiments.

### DETAILED DESCRIPTION

The following detailed description is exemplary in nature and is not intended to limit the scope, applicability, or configuration of the invention in any way. Rather, the following description provides some practical illustrations for implementing some embodiments of the invention. Examples of hardware configurations, systems, processing circuitry, data types, programming methodologies and languages, software implementation, communication protocols, and the like are provided for selected aspects of the described embodiments, and all other aspects employ that which is known to those of ordinary skill in the art. Those skilled in the art will recognize that many of the noted examples have a variety of suitable alternatives.

As will be discussed herein, some embodiments provide systems, devices, and/or methods for analyzing, determining, and/or reviewing digital communications, digital documents, and/or the messages and text within digital documents. Accordingly, some embodiments generally relate to digital communications and the various types of digital documents that can be generated, sent, and received with an electronic communication system.

Some embodiments of the invention may provide for the analysis of digital communications in one or more contexts, and it should be appreciated that the invention is not limited to any particular application or context. For example, some embodiments may provide the capability to analyze the content of a digital document that is generated, transmitted, and/or received as part of a digital communication transmitted (or intended to be transmitted) through a communication network. Some embodiments can include the use of an electronic communications system to generate, transmit, receive, or otherwise interact, engage, or handle a digital document. Some embodiments may provide analyzing of digital document text or content independently of actual transmission between two parties.

In some cases types of digital documents that may be analyzed include, but are not limited to, text files, word processing documents, email correspondence, text messages, multimedia messages, instant messages, web page files, and other types of digital computer files containing digital text or message content. In some cases, embodiments may provide a characterization of the text within a digital document (sometimes also referred to herein as the “message” or “communication” of the digital document) based on one or more text characterization factors that correspond to respective aspects, elements, and/or components of the text of the digital document. One non-limiting example is a factor comprising an ambiguity score corresponding to an aspect of the digital text such as the ambiguity and/or clarity of the text in the digital document.

Other possible components and/or aspects of a digital communication that may be analyzed, and for which one or more corresponding text characterization factors may be determined include, but are not limited to the follow examples:

Subject Matter—This aspect may be considered the core or essence of a digital communication, and may refer to words, phrases, and the context in which they are used, in order to relate the point or story of the message. A set of lexical features that can express at least in part the core topics of a communication are keywords. In some cases the keywords may possibly be weighted by Term Frequency vs. Inverse Document Frequency (i.e., TFIDF—the frequency of the feature within the communication itself is normalized with its general frequency in the language.

Clarity—This aspect can refer to communications that are generally or substantially direct, obvious, objective, and/or unambiguous, free of “figures of speech,” colloquialisms and/or clichés at least to the extent they may hinder an understanding of the text of the communication. Clarity can be contrasted with ambiguity and is related to whether the communication contains enough information to remove the recipient's uncertainty regarding the meaning of the communication.

Formality—This aspect can include a computational expression embodying things such as the author/recipient relationship (friend, associate, stranger, etc.), and/or the underlying purpose of the communication (casual, business, legal, etc.).

Sentiment—This aspect relates to a computational expression of an opinion in the text of a digital document, indicating affinity, dislike, or neutrality of emotion.

Tone—This aspect can provide a computational expression indicating a state of emotion(s) in the text of the digital document that may be characterized by, e.g.,

Direction—suggestion, directive, demand;

Severity—casual, important, imperative;

Aggression—prodding, chiding, forceful;

Affection—like, love, dislike, hate; and

Passion—passive/neutral, concerned, angry, enraged.

Tone may indicate a state of one or more emotions including those provided by established theories of human affect, for example those underlying the Affective Norms of English Words such as Valence (pleasant to unpleasant), Arousal (calm to excited) and Dominance (dominance to loss of control) or those underlying the Profile of Mood States such as Calm, Clearheaded, Confident, Friendly, Happy, and Energetic. The above dimensions of tone can be combined to produce a range of compound tone indicators that can be identified by expressions such as for example “business tone” that end-users can readily recognize.

Confusion—This aspect relates to a situation or state of mind in which product analysis or recipient analysis of a digital communication results in uncertainty of the meaning or intent of the message.

Subjectivity—This aspect relates to computational expressions in text that include words, phrases, or contextual arrangements of the same, resulting in multiple interpretations of the communication.

Objectivity—This aspect relates to computational expressions in text devoid of subjectivity.

Embodiments described herein, as well as modifications based upon the described embodiments, may also be useful in conjunction with a wide variety of existing and/or contemplated software applications. For example, some embodiments may be configured to provide plug-in software for other software applications such as, e.g., mail applications such as Microsoft Outlook and Google Gmail, word processing applications such as Microsoft Word, marketing software such as ExactTarget and Constant Contact, sales software such as software by Salesforce, and/or social media platforms such as Twitter and Facebook. In some cases, methods described herein may be useful to implement a call center quick response “editor”, and/or useful in writing text to be delivered by speech, such as political speeches. Other applications will be described and will be otherwise apparent to those skilled in the art. Of course these are just some possible examples of applications for some embodiments, and embodiments and practice of the invention is not necessarily limited to any particular context, configuration, and/or embodiment.

In addition, in some cases a digital communication and/or text within a digital communication and/or digital document can be reviewed at one or more times. One example includes reviewing and analyzing portions of the text of a digital document during composition of the communication. Some embodiments may, for example, enable the user to interact with the system to review and possibly change and/or correct certain words and/or phrases during the composition of the message. The system may, for example, notify the writer while he or she is composing the message, thus enabling the writer to change his/her style, word choice, formatting, and the like before completing the entire message. Some embodiments may also or instead review a composition prior to sending the communication. For example, the system may let the user choose to, or may automatically, analyze a completed message prior to sending.

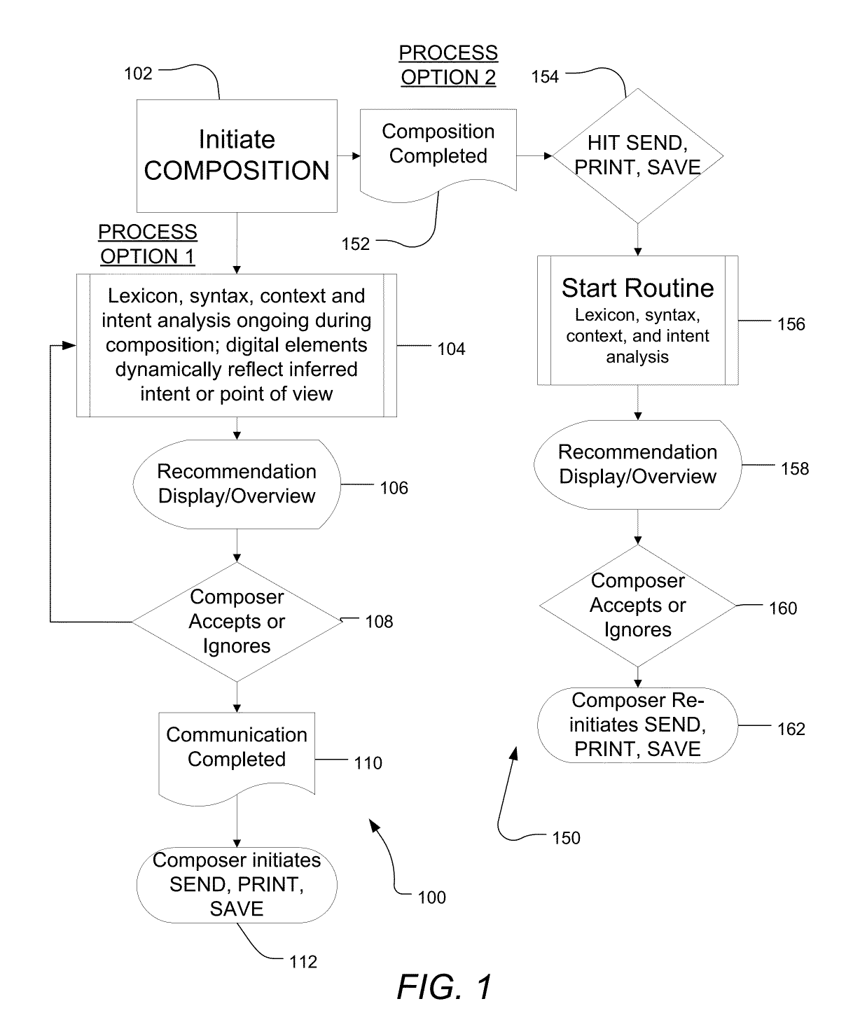

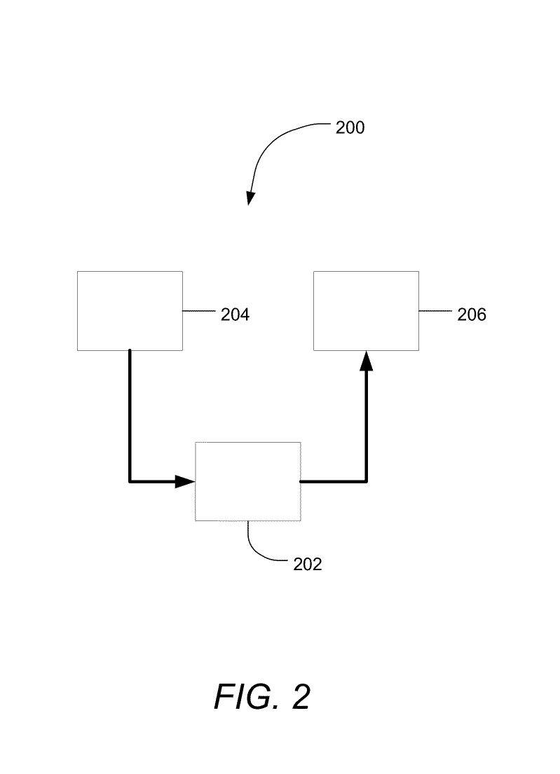

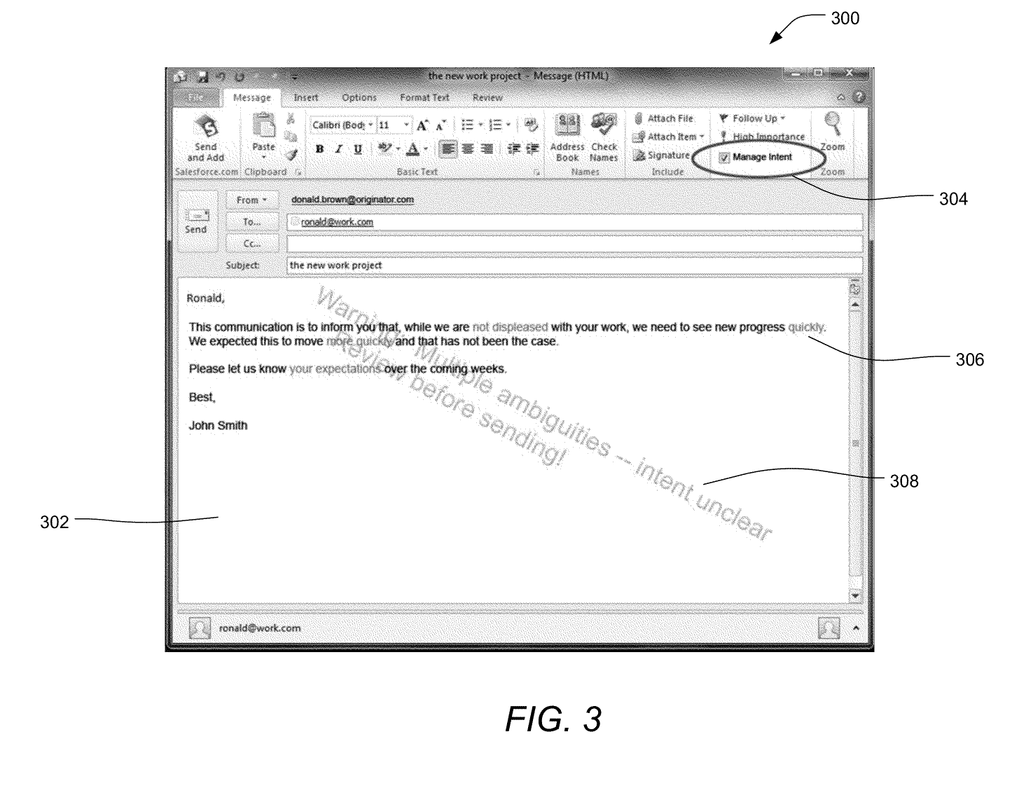

As will be discussed in greater detail below with respect to FIG. 1, embodiments of the invention may provide various methods and/or processes for analyzing the text of digital documents/communications. With further reference to FIG. 2, examples of some possible physical implementations of systems and/or methods for analyzing digital documents are provided. Several possible applications and associated user interfaces for reviewing digital communications according to some embodiments of the invention will be subsequently described with respect to FIGS. 3-11E. Finally, FIGS. 12-15 are discussed further below and provide a number of examples of analysis methods and criteria that are used and/or can be used in some embodiments.

Returning to the topic of possible features, functions, and capabilities, embodiments may provide a wide variety of functionality in the course of reviewing and analyzing digital communications or other text. In some cases an embodiment can identify words and phrases according to one or more predetermined criteria. As just some examples, a system/method may analyze the text of a message and identify subjective and/or ambiguous terms such as words, phrases, fonts, punctuation, contextual cues and other elements of the communication that may lead to misinterpretation of the sender's intent of the communication by the recipient. Some embodiments may separate communication elements during composition and instantly query a syntax database to identify possible words, phrases, styles, formatting, and the like that a user may desire to change to more accurately convey the user's intention in the communication.

According to some embodiments, a communication method or system can provide feedback to the author of the message based on an analysis of some or all of the communication. In some cases, a system may return and display suggestions to clarify and/or improve a desired point of view. In some examples a system may return and display suggestions to make the message more objective. An embodiment of the system could include configurable alerts that would notify the author as questionable words or phrases are entered. In some cases the author of the communication may only be notified after an entire message is analyze prior to sending.

Some embodied systems can include a scoring mechanism that scores elements within a communication or characteristics of a digital communication. In some cases, the scoring mechanism can provide a progressive contextual analysis of the message as a whole, providing some type of notification (e.g., graphical icon) suggesting to the author an overall recommendation of whether to send or not send the communication (e.g., a composite “go-no go” recommendation).

Some embodiments can provide a message labeling system. For example, in some cases the user or writer may initiate the message labeling system, which can assign common contextual labels to various portions of the communications. Some examples of a label include specific words such as “directive,” “demand,” “suggestion,” or other meaningful words or phrases. Some examples include shading of text, highlighting the background behind text, inserting a watermark behind the text, and/or some other mechanism to indicate further consideration of the marked portions of the communication may be desirable before sending the message.

According to some embodiments, a system/method/apparatus may suggest that the author record a message and attach an audio file to the written communication. As just one example, the system may be unable to determine an intended meaning of a word or phrase. In such a case, the system could suggest to the user to create an audio recording of all or a portion of the message to send along with the written communication. Upon activation, the system may then record and store an audio segment for sending to the recipient.

Systems and methods according to some embodiments may be able to review, analyze, and provide suggestions for communications, messages, and other text in a wide variety of digital documents. As mentioned above, some examples of possible digital documents for which an embodiment may be useful include, but are not limited to, text files, email messages (e.g., on a desktop PC, smart phone, Internet-based, etc.), text messages, multimedia messages, instant messages, web page files, word processing (e.g., Microsoft Word) documents, and other documents containing text written by an end user or otherwise embodied as a digital computer file containing digital text or message content.

Some possible processes and/or methods for reviewing digital communications will now be discussed. According to some embodiments, a method for reviewing digital communications may include one or more of the following steps:
review and/or analyze the content of a digital communication for certain words and phrases (e.g., based on criteria such as subjectivity, intent, meaning, subject matter, ambiguity, confusion, sentiment, tone, formality, clarity, etc.);
conduct such a review and/or analysis using computer-based algorithms (such as artificial intelligence, machine learning, etc.);
notify the author of the identified content of a communication in which revisions may be needed;
notify the author of a possible point of view and/or possible implied intent associated with certain words and/or phrases;
propose suggestions for changing the identified content (e.g., to make the communication more objective, less capable of misinterpretation, more accurately reflect the intended meaning, etc.);
notify the author of analysis results such as the determined intent, identified ambiguities, and provide corrective advice in a suitable format, for example, using color, light, italicizing, other font changes, or other identifiers. In some cases suggested corrections may appear when hovering a pointer over identified text; and
provide the author with a summary and/or scoring of the identified content of a communication where revisions may be needed.

In some embodiments, the sender/author may also or instead be able to select from a menu listing different contexts/intents/tones to inform the system of the sender's intentions for the communication. This can provide the system with the desired point of view, context, tone, etc., so the system does not have to make the determination based solely on contextual cues in the text.

According to some embodiments, a filter may enable modification of a communication after it has been written (e.g., in “reverse”) so that it satisfies the sender's intent. For example, the author may inform the system of a desired intent or tone (e.g., angry, sad, happy, etc.) and the system may make suggestions for modifying the current message to possibly align it more with the desired intent, tone, and/or emotion.

Two additional possible processes for reviewing/analyzing digital communications will now be discussed with respect to FIG. 1. FIG. 1 is flow diagram illustrating two processes 100, 150 for reviewing digital communications according to some embodiments. Each process starts by initiating the composition 102 of a message. In a first process 100, context, syntax and other factors are checked 104 during composition. Upon identifying a particular word or phrase that the system determines should be reviewed, the system displays a recommendation message 106, such as a pop-up window and/or an overview of certain recommended changes. In some cases the system provides a suggestion and allows the user to accept or ignore the suggestion 108. The process then continues analyzing the message as it is composed, identifying possible words or phrases for modification and presenting the user with the opportunity to make changes, until the communication is completed 110. The author/composer can then send, print, and/or save 112 the message.

In a second possible process 150, the author/composer completes the composition 152, and then may send, print, and/or save the message 154, which initiates the checking 156 of context, syntax and other factors after the composition is completed. The system displays a recommendation message 158, such as a pop-up window and/or an overview of certain recommended changes. In some cases the system provides a suggestion and allows the user to accept or ignore the suggestion 160. In some cases, the process 150 may stop analysis 156 to display recommendations 158 after identifying each word or phrase, and then continue with analysis 156. In certain cases, the process 150 may continue through the entire message to identify all words or phrases in the message that might need review before entering step 158 to display recommendations. After reviewing all recommendations in step 160, the system may then proceed (e.g., automatically) to re-initiate the user command (e.g., send, print, save) that started the process 150.

As previously mentioned, in some cases systems and/or methods for reviewing digital communications can be implemented with stand-alone software systems and/or software systems that are integrated with other software (e.g., plug-ins, add-ons, add-ins, etc.) or that are called by other software. In such cases it should be understood that embodiments are provided by one or more of many possible forms of processing circuitry or hardware configured to specifically carryout the desired features and functions, including analyzing digital communications and/or displaying the results of the analysis. A few examples of possible hardware, software, firmware, and/or other implementations will now be described with respect to FIG. 2.

FIG. 2 is a high level schematic diagram of a system 200 for reviewing digital communications according to some embodiments. The system 200 includes processing circuitry 202, an input device 204, and an output device 206. In some cases the input device 204 may be a keyboard, a touch screen, a computer mouse or other pointing device, or any other suitable device capable of receiving an input from a user and relaying the input to the system's processing circuitry. In some cases the output device 206 is an electronic display, such as a display using CRT, plasma, LCD, LED, OLED, or any other suitable electrical technology. In some cases, the input device 204 and the output device 206 may be provided by the same device, such as by a touch-sensitive screen (e.g., incorporated into a smart phone or tablet computer).

The processing circuitry 202 may include a number of well-known components. For example, in some embodiments the processing circuitry 202 includes a programmable processor and one or more memory modules. Instructions can be stored in the memory module(s) for programming the processor to perform one or more tasks. In alternate embodiments, the processing circuitry 202 itself may contain instructions to perform one or more tasks, such as, for example, in cases where a field programmable gate array (FPGA) or application specific integrated circuit (ASIC) are used.

The processing circuitry 202 shown in FIG. 2 is not limited to any specific configuration. Those skilled in the art will appreciate that the teachings provided herein may be implemented in a number of different manners with, e.g., hardware, firmware, and/or software. For example, in many cases some or all of the functionality provided by embodiments may be implemented in executable software instructions capable of being carried out with processing circuitry such as a programmable computer processor. Likewise, some embodiments the processing circuitry can include a computer-readable storage medium (e.g., a non-transitory medium that can store instructions) on which such executable software instructions are stored.

The term “non-transitory” is used herein to indicate that a computer readable storage medium is a physical medium that stores instructions, and is not a transitory signal per se. The term “non-transitory” includes other types of computer readable storage media such as internal or removable storage devices used within or in conjunction with a computer processor at run time and/or for longer term data retention, including volatile and/or non-volatile forms. As just a few nonlimiting examples, a non-transitory computer readable storage medium can be any one of a number of memory devices normally included in or used with a computer processor. Such examples may include a CD ROM, a DVD ROM, a hard disk, RAM, and other such devices.

Returning to FIG. 2, the system 200 also includes the input device or module 204, which may be provided in any suitable form. For example, the input device 204 can include a keypad, keyboard, pointing device, touch screen, any generally acceptable input mechanism, or a communication line connected to the processing circuitry 202 in order to forward inputs to the processing circuitry. The system 200 also includes the output device 206, such as an electronic display, in communication with the processing circuitry 202 for receiving and displaying electrical signals representative of data to be displayed to a system user. The system 200 may include a wide variety of other components not shown in FIG. 2. Communication between modules may be provided in any suitable form, such as wired and/or wireless.

Although not shown, components of the system 200 may be incorporated into a single device, such as personal computing devices, desktop or laptop computers, tablet computers, personal digital assistants (PDAs), mobile telephones, smart phones, netbooks, or other electronic devices using processing circuitry. In certain embodiments, the system 200 may include multiple processors and memory components and/or may be distributed across a network or across multiple locations. For example, a remote server having one or more processors and memory components may host an interactive application that is accessible from one or more other devices, such as a PC or a smart phone.

As mentioned above, the system 200 may have multiple components distributed across a network. In some cases, the system 200 may also be configured to connect with a computer network to communicate with other devices. The network may be any type of electronically connected group of computers including, for instance, the following networks: Internet, Intranet, Local Area Networks (LAN), Wide Area Networks (WAN) or an interconnected combination of these network types. In addition, the connectivity within the network may be, for example, remote modem, Ethernet (IEEE 802.3), Token Ring (IEEE 802.5), Fiber Distributed Datalink Interface (FDDI), Asynchronous Transfer Mode (ATM), or any other communication protocol. Communications within the network and to or from the computing devices connected to the network may be either wired or wireless. Wireless communication is especially advantageous for network connected portable or hand-held devices. The network may include, at least in part, the world-wide public Internet which generally connects a plurality of users in accordance with a client-server model in accordance with the transmission control protocol/internet protocol (TCP/IP) specification.

As just one possible example from among many, according to some embodiments, systems and/or methods may incorporate an approach in which applications that are compatible with a variety of platforms, both in terms of hardware (desktops and mobile platforms) and software (plug-ins for social media applications, email clients, text editors, etc.) are distributed to end users. The apps are installed on the client side and operate largely independently, but connect to a back-end system database server via a secure API. In the latter case, the browser is an independent application that runs on a computing device such as a laptop, phone, and tablet, but which makes live requests to the system backend. In some embodiments, the application may only make calls back to the main server to enable additional services, which could be made available on a subscription or click-through basis.

Several possible applications and associated user interfaces for reviewing digital communications according to some embodiments of the invention will now be described with respect to FIGS. 3-11E.

FIG. 3 is a depiction of an email application 300 showing a message composition screen 302 on a personal computer according to some embodiments. A system for reviewing the message composition is integrated with the email application 300 and provides a toolbar feature 304 for accessing certain functions provided by the system. In this example, the toolbar feature 304 includes an option to manage context which can be enabled by marking a checkbox (e.g., illustrated as an option to “manage intent” though this is just an example intended to indicate managing an aspect of message context). Enabling the system causes the system to review the text of the message in the message screen 302 and notify the user of certain words and/or phrases that may need review. For example, as discussed above, the system may highlight certain words 306 or display the words in a different font or color to notify the user that the choice of words and/or phrases may make the sender's intent, tone, perspective, etc., ambiguous or confusing. In some cases the system may provide the user with suggestions for replacing the emphasized text. In some cases the system may include a global notifier 308, in the form of a watermark, pop-up balloon, or other form, to indicate to the user that multiple possible ambiguities are present based on a review of the entire communication.

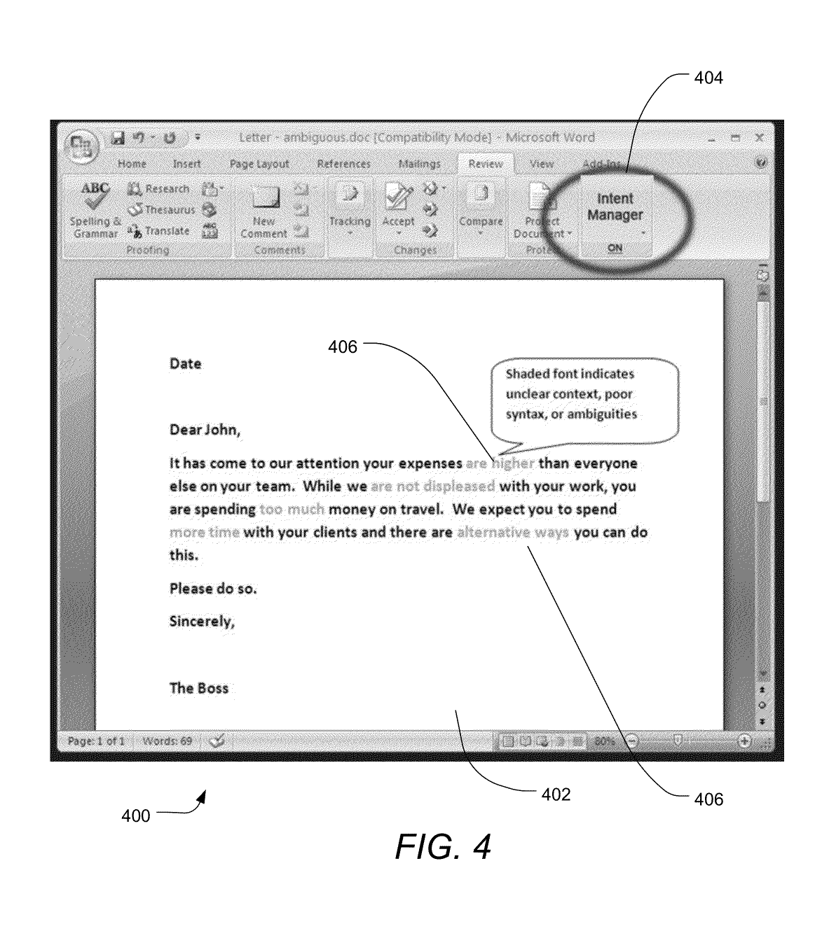

FIG. 4 is a depiction of a word processing application 400 showing a composition screen 402 on a personal computer according to some embodiments. A system for reviewing the composition is integrated with the word processing application 400 and provides a toolbar feature 404 for accessing certain functions provided by the system. In this example, the toolbar feature 404 allows enablement of a “Context Manager” (e.g., illustrated as an option to “intent manager” though this is just an example intended to indicate managing an aspect of message context). Enabling the system causes the system to review the text in the composition screen 402 and notify the author of certain words and/or phrases that may need review. For example, as discussed above, the system may highlight certain words 406 or display the words in a different font or color to notify the user that the choice of words and/or phrases may make the sender's intent, tone, perspective, etc., ambiguous or confusing. In some cases the system may display text boxes or other indicators to notify the user. In some cases the system may provide the user with suggestions for replacing the emphasized text.

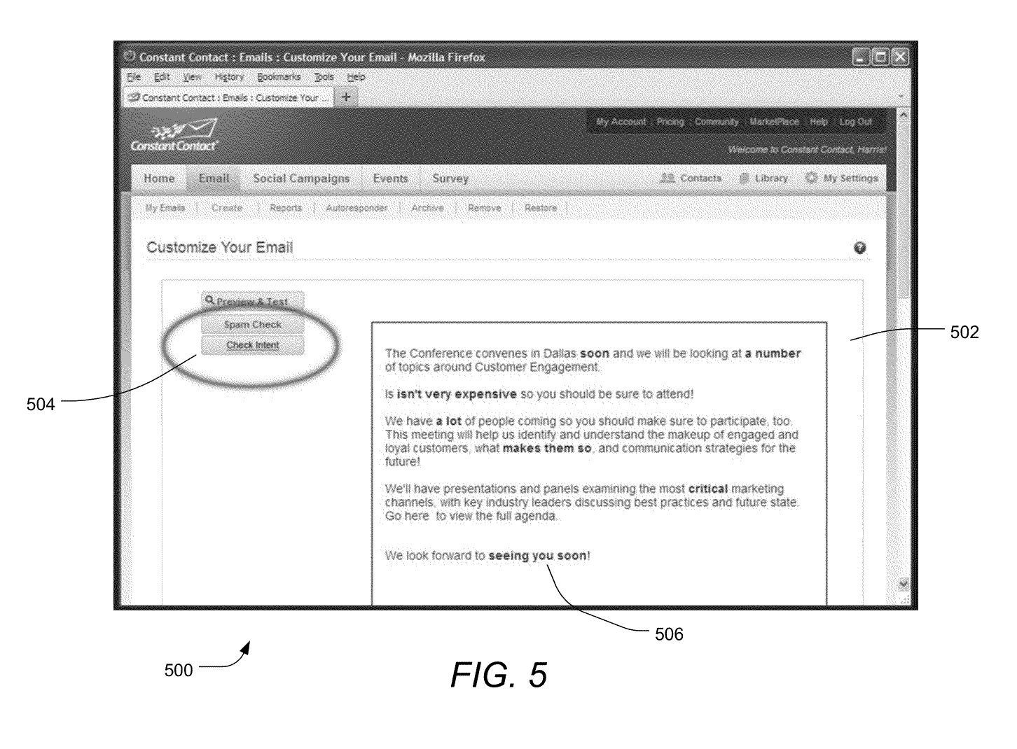

FIG. 5 is a depiction of an Internet-based email application 500 showing a message composition screen 502 on a personal computer according to some embodiments. A system for reviewing the message composition is integrated with the email application 500 and provides a menu feature 504 for accessing certain functions provided by the system. In this example, the menu feature 504 includes an option to “Check Context,” which can be enabled by clicking a button (e.g., illustrated as an option to “check intent” though this is just an example intended to indicate managing an aspect of message context). Enabling the system causes the system to review the text of the message in the message screen 502 and notify the user of certain words and/or phrases that may need review. For example, as discussed above, the system may emphasize certain words 506 (e.g., by highlighting, changing the font, color, etc.) to notify the user that the choice of words and/or phrases may make the sender's intent, tone, perspective, etc., ambiguous or confusing. In some cases the system may provide the user with suggestions for replacing the emphasized text.

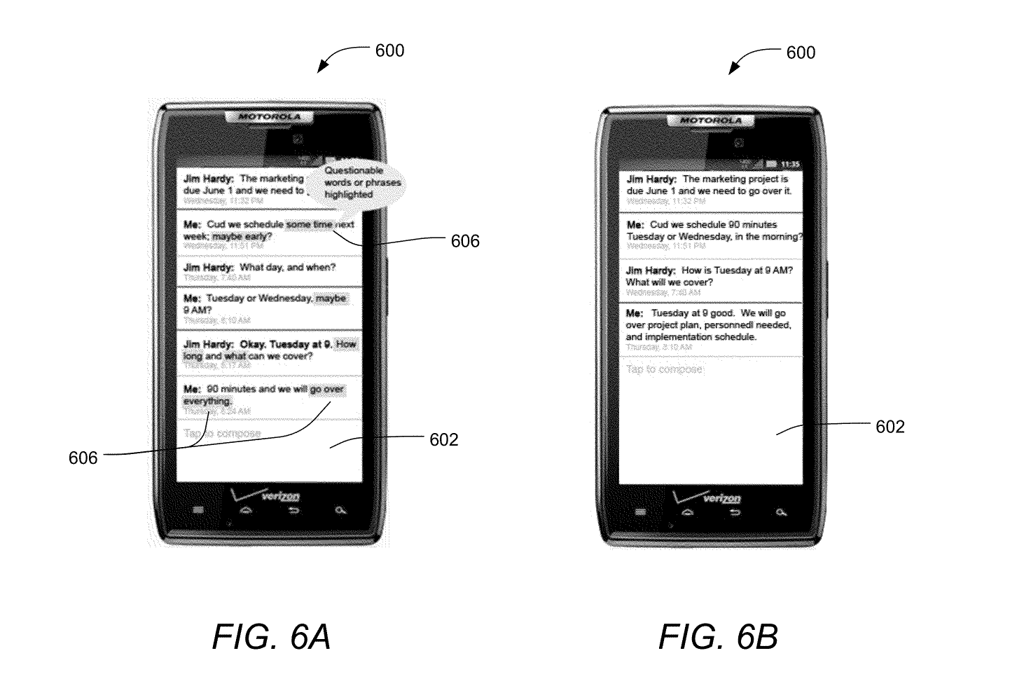

FIGS. 6A and 6B are depictions of a text messaging application on a smart phone 600 according to some embodiments. A system for reviewing the message composition is integrated with the text messaging application. The system may be accessible to a user through a menu or settings option, or another suitable method. Enabling the system causes the system to review the text of the message in the message screen 602 and notify the user of certain words and/or phrases that may need review. The example in FIG. 6A illustrates how the system may emphasize certain words 606 (e.g., by highlighting, changing the font, color, etc.) to notify the user that the choice of words and/or phrases may make the sender's intent, tone, perspective, etc., ambiguous or confusing. In some cases the system may display text boxes, balloons or other indicators to notify the user. In some cases the system may provide the user with suggestions for replacing the emphasized text. The example in FIG. 6B illustrates how the message in FIG. 6A could be modified using the word/phrase highlighting and/or replacement suggestions provided in some embodiments of the system. In some cases an embodiment of the invention can provide a message that is more concise, has greater clarity and little or no ambiguity. As shown in FIGS. 6A and 6B, this can result in a fewer number of messages needed to convey the same intended meaning.

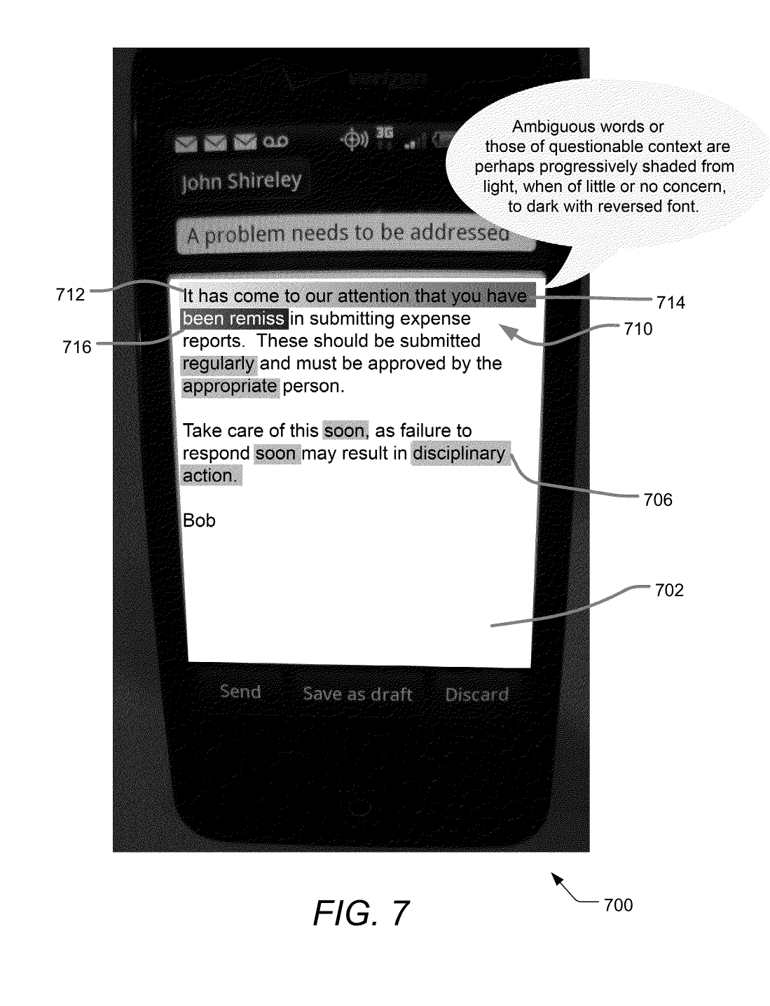

FIG. 7 is a depiction of an email application on a smart phone 700 according to some embodiments. A system for reviewing message text can be integrated with and/or called by the email application to review text in the message. The system may be accessible to a user through a menu, a settings option, a toolbar, or another suitable method. According to some embodiments, the system analyzes the text of the message on the application screen 702, and provides feedback to the user regarding possible interpretations of and ambiguities within the text.

Enabling the system causes the system to review the text of the message in the message screen 702 and notify the user of certain words and/or phrases that may need review. In some embodiments, the system analyzes the syntax and context of each word and phrase (e.g., by referencing a grammar/syntax database), and progressively changes the color of one or more words, phrases, or other elements according to a pre-determined scheme that corresponds to the analysis of the respective words, phrases, and other elements. In some cases, this process may be referred to as a dynamic colorization scheme that represents changes in a perceived intent of the communication. For example, review or analysis of particular grammatical elements of a digital communication may cause the system to determine an implied intent suggested by the elements. Based on the intent analysis, the system can progressively initiate a change of the background color in a readily understood pattern to indicate the perceived intent, connotation and point of view of the message originator.

According to some embodiments, the system may provide message analysis and dynamic colorization during composition (e.g., process 100 in FIG. 1) or after composition and prior to sending a communication (e.g., process 150 in FIG. 1). For example, the colorization may be used to notify the originator of the communication as to how his or her message will likely be interpreted by the recipient (i.e. serious, angry, pleased, fun, etc.). In some cases it may be used to suggest recommended changes in the message prior to sending, in order more correctly satisfy the purpose of the message originator.

According to some embodiments, the system may instead or also be used by a recipient to analyze the content of a received message or other text. For example, after receiving an email, word processing document, or other digital document containing text, a recipient may be able to use the system to analyze the text of the received text. In some cases the system may then notify the recipient of the message of possible points of view, implied intent(s), emotions, and other aspects reflecting the author's state of mind.

Returning to FIG. 7, upon activation the system begins analyzing the text in the message on the screen 702. According to some embodiments, the system analyzes the text of the message on the application screen 702, and provides feedback to the user regarding possible interpretations of and ambiguities within the text. In some cases, the system may highlight or otherwise emphasize words or phrases 706 that the user should review for possible clarification.

According to some embodiments, as the system analyzes the message text, the system may interpret and rank words or phrases according to a predetermined scale. The system may then change the color behind the text (or otherwise notify the user) corresponding to the interpretation/ranking determined by the system. With respect to FIG. 7 for example, if the system determines that words or phrases are deemed innocuous, pleasant, etc., the system may change the background behind the corresponding words/phrases green. If the system determined that the text turns increasingly negative in tone, the system may change the background behind the corresponding words/phrases 710 red. According to some embodiments, the color change may be gradual, with the rate of color change depending upon factors such as the rate at which the tone or implied intent of the text changes. In some cases an intermediate or neutral color (e.g., yellow in FIG. 7) may be used to highlight possibly ambiguous words/phrases to indicate that the user should take caution when using the highlighted words or phrases.

One example of an embodiment includes a system that performs a method of analyzing the text of an email or letter. In the example, the message may begin with a salutation, e.g., “Dear [name].” If the system recognizes the name as a friend, family member, or other familiar person, then the system immediately turns the message background green (for “good to go”). If the message continues in a friendly manner, then the system may maintain the background color green. In some cases, the system may vary the shade or other aspect of a single color to indicate further information about the highlighted words. For example, the system could use a deeper shade of green to indicate that a word or phrase has an even more favorable than other surrounding words. In some cases the system may recognize the formal aspect of a message and turn the corresponding background to a neutral color. As an example, the system may determine that the phrase “it has come to our attention . . . ” has a formal nature and then change the background to a neutral, e.g., yellow color. Continuing with the example, upon analyzing the phrase “that there is a significant problem with . . . ”, the system may determine that the chosen words call for caution and may turn the background a shade of red. In addition, in some cases, words such as “significant” may be highlighted to indicate further review may be desirable. For example, the system may generate a comment that a words is “subjective” and the user should consider “objectifying” the text. In some cases, the system may incorporate a watermark that presents both a colorized and verbal tag.

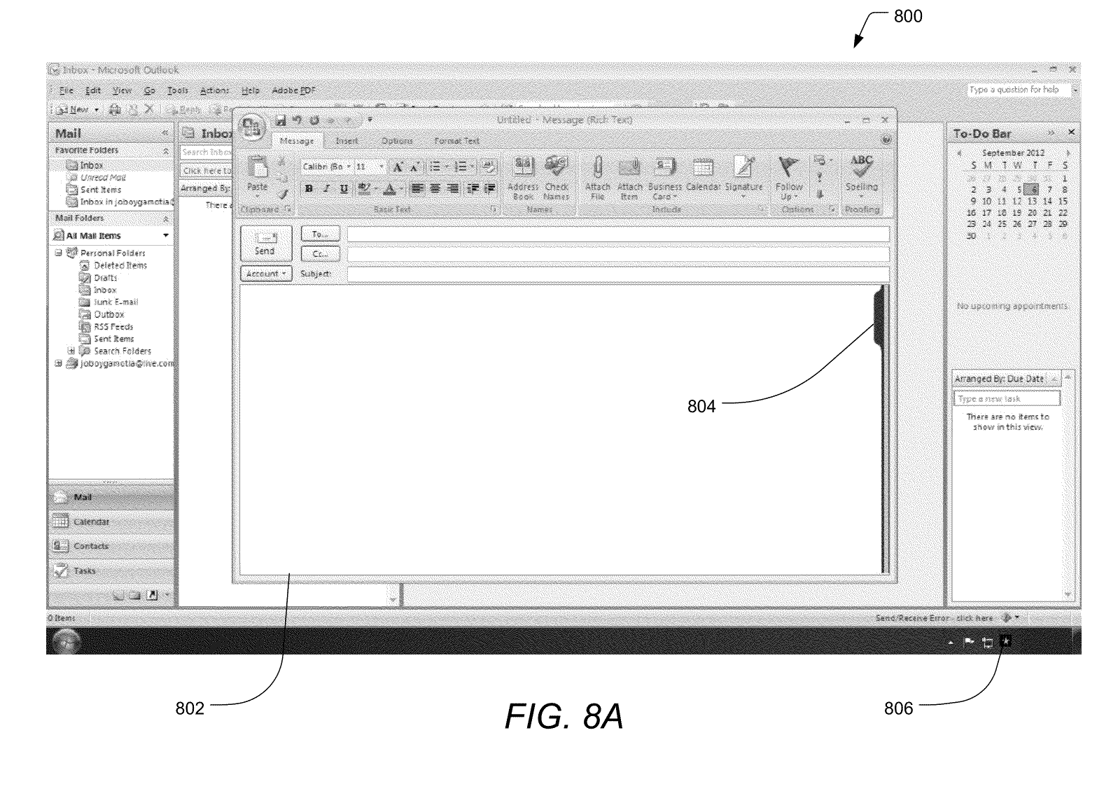

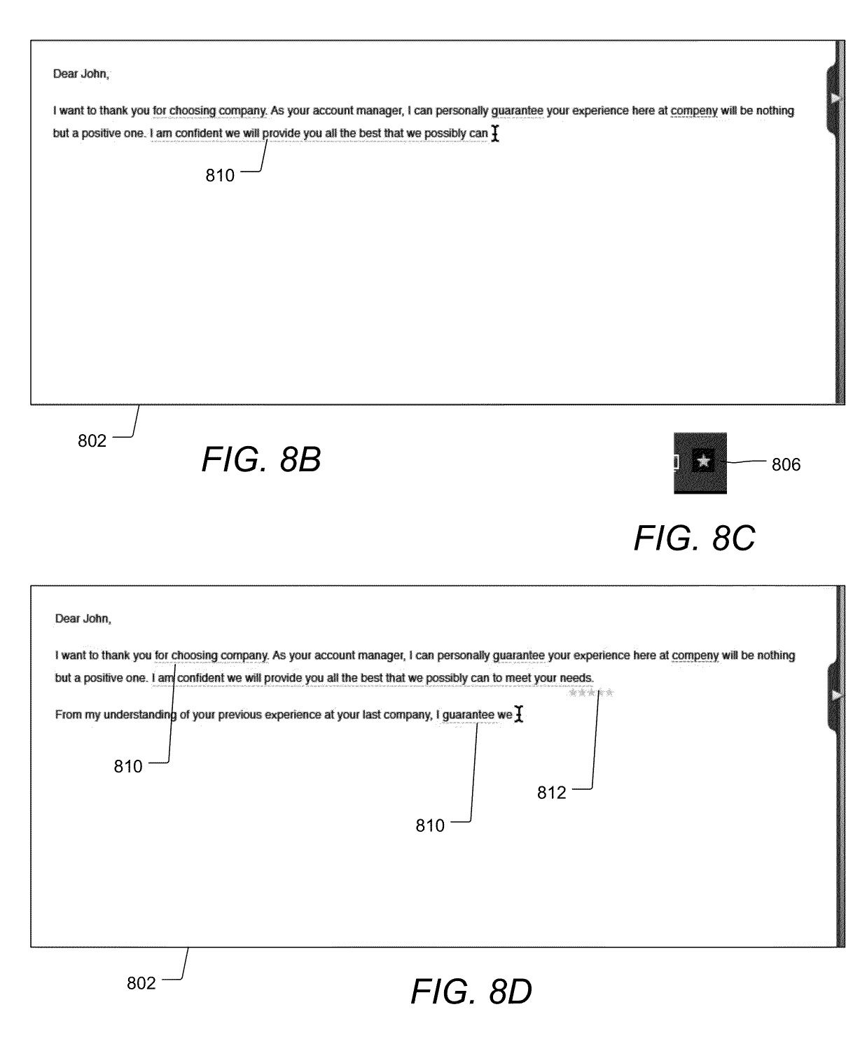

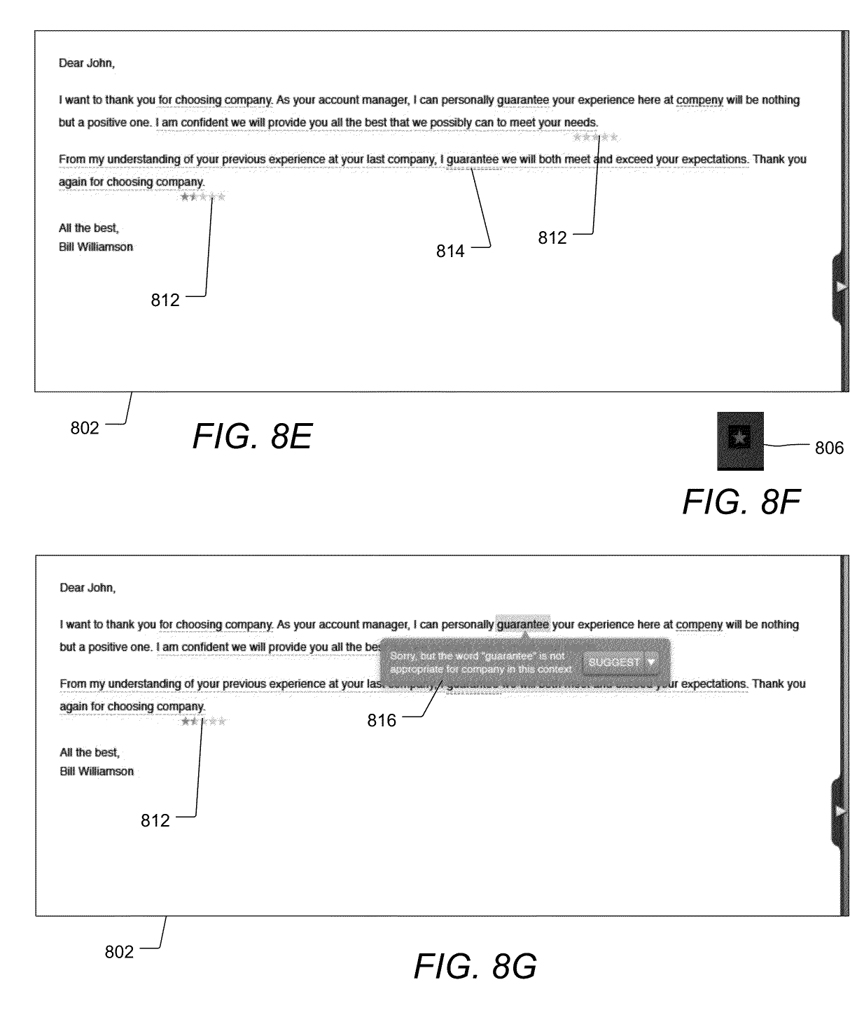

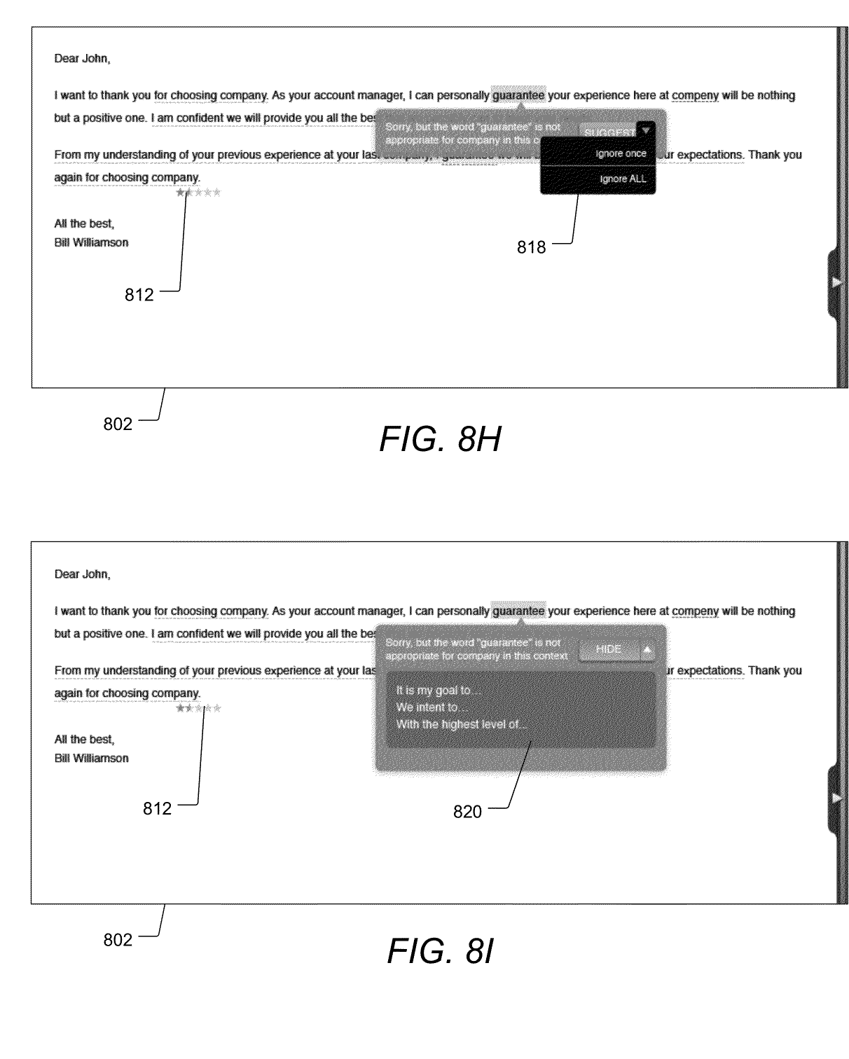

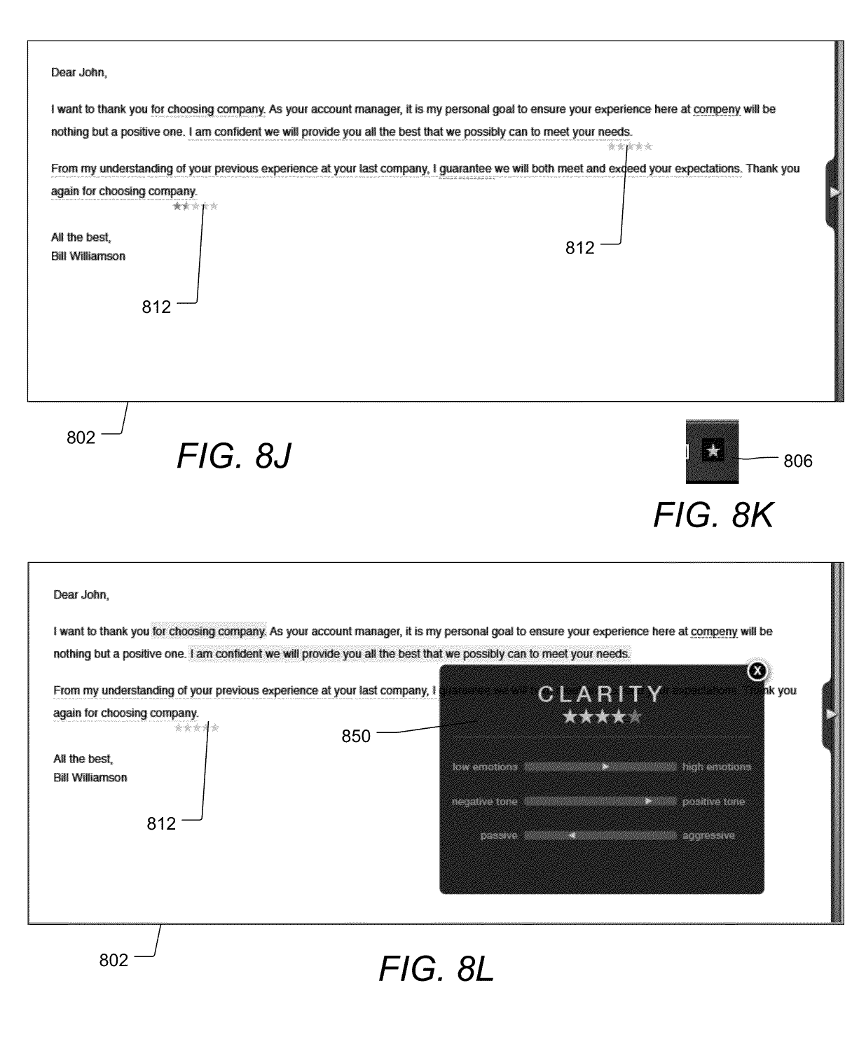

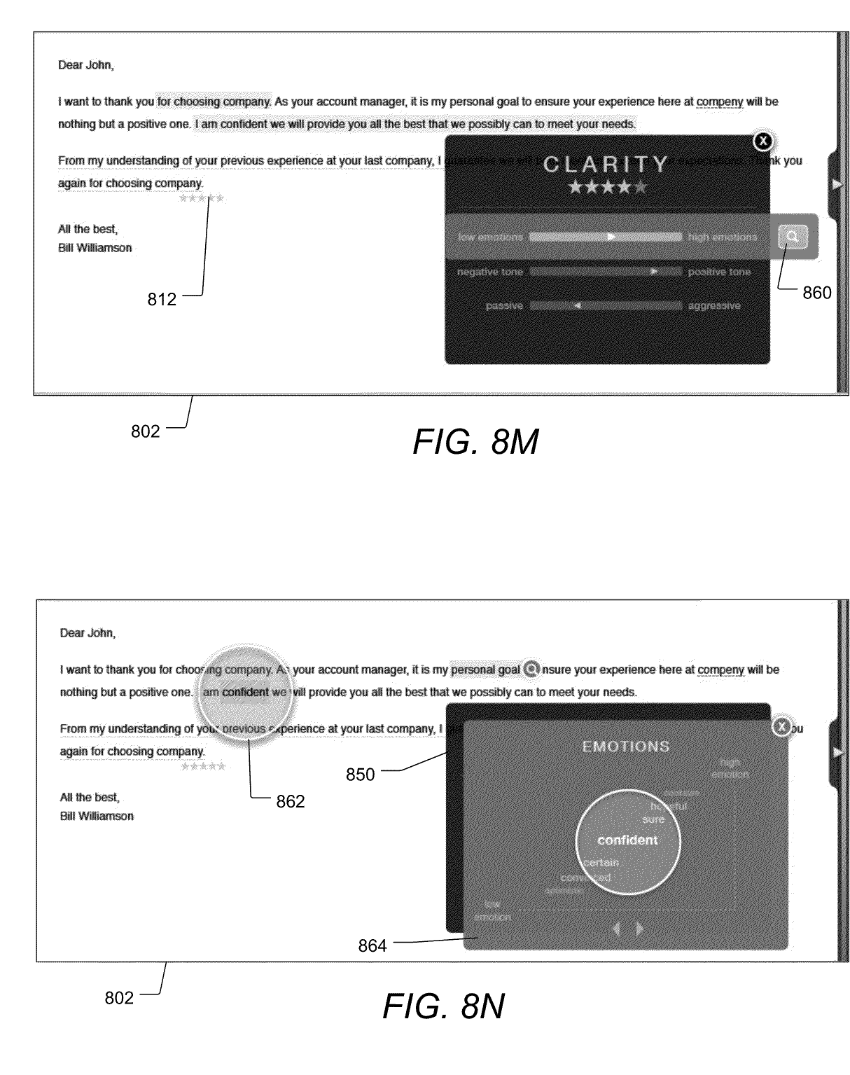

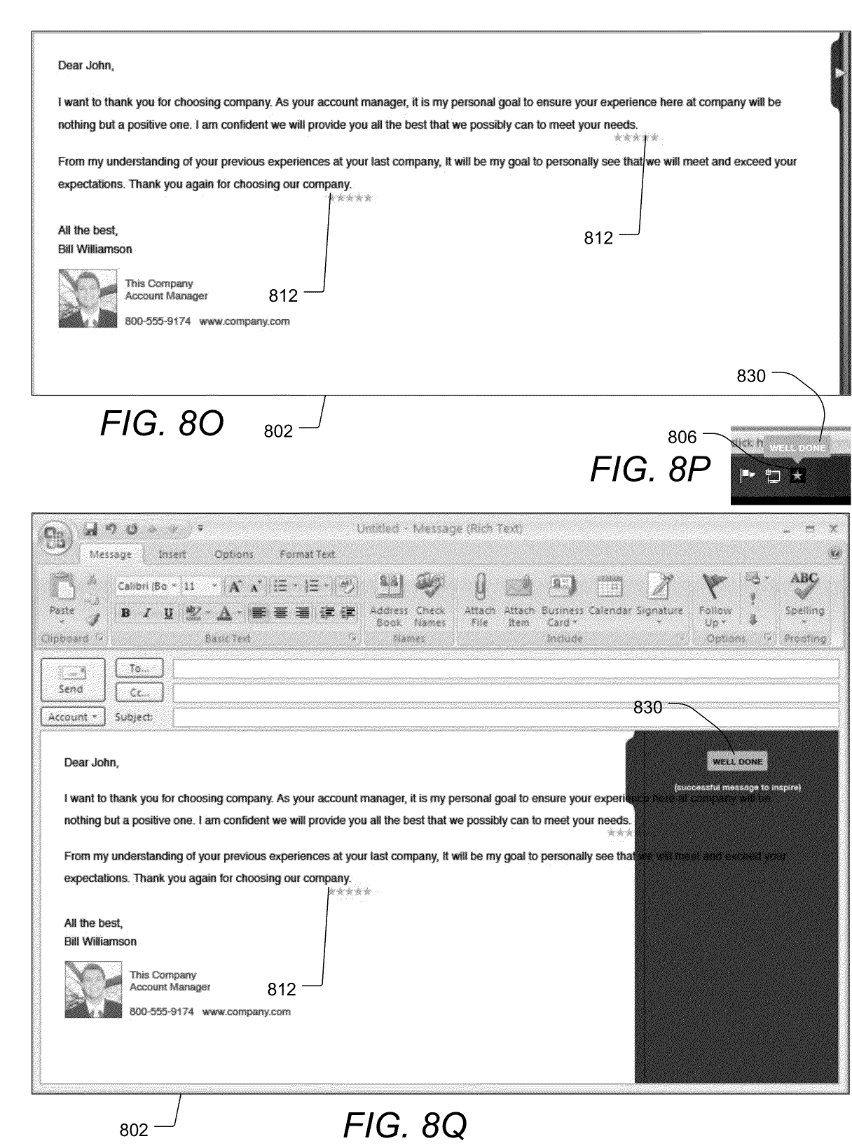

FIGS. 8A-11E are depictions of another possible embodiment of a system that can be used to review and revise digital communications. In this case, the system includes an email software application 800 running on processing circuitry (not shown) with an integrated plug-in for reviewing the content of email messages being composed and/or received. As illustrates, the system can also include a number of administrative and/or reporting functions.

FIGS. 8A-8Q illustrate the email application 800 with an open message composition window 802. FIG. 8A also depicts two possible examples of message status indicators 804, 806. One of the message status indicators 804 is displayed as part of the message composition window, while the other message status indicator 806 is displayed as a notification icon in the system tray of the operating system software graphical user interface. As a user types a message into the message composition window 802, the system reviews and analyzes the text of the message for potential ambiguities and other criteria. In cases where the system identifies text meeting predetermined analysis criteria regarding ambiguity and other factors, the system highlights the identified text with visible markers such as, for example, underlines 810 and star ratings 812 (to indicate a relative rating), for further review by the user. In some cases the system may provide a distinct visible marker, such as a double underline 814 or other suitable marker, for words or phrases that have been identified as specifically undesirable, inappropriate, or not allowed in certain contexts. In some cases, the system may present a dialog box 816 (e.g., upon hovering the cursor over the word) that explains why the word or phrase was marked and in some cases may display a dialog box 818 that allows the user to ignore one or all instances of the identified term and/or may display a dialog box 820 that provides suggested or possible alternative text.

Again referring to FIGS. 8A-8Q, the system may automatically adjust the display of one or both indicators 804, 806 to visually indicate the current status of the message analysis as a user types a message into the message composition window 802. For example, referring to the figures, the message status indicator 804 is provided in the form of a color-coded gradient bar with a sliding indicator. In this example, as the system determines that the current state of the message being composed is becoming less ambiguous and more clear, the sliding indicator moves toward the top of the bar which is color-coded green (see, e.g., FIGS. 8A, 8B, 8D, 8O). Conversely, as the system determines that the current states of the message being composed is becoming more ambiguous and less clear, the sliding indicator moves toward the bottom of the bar which is color-coded red in this example (see, e.g., FIGS. 8E, 8G, 8H, 8I). In a somewhat analogous fashion, the system tray indicator 806 may also change colors or exhibit other display changes as the clarity/ambiguity of the message changes (see, e.g., FIGS. 8A, 8C, 8F, 8K, 8P). As shown in FIGS. 8P and 8Q, a final display message 830 may be provided to indicate that the user has successfully corrected for the identified ambiguities and that the message is now more clear than before.

Referring to FIGS. 8L, 8M, and 8N, in some cases the user may select one or more of the visibly-identified phrases or words to further investigate the system's analysis of the identified text. For example, by clicking on the star ratings 812 as shown in FIG. 8L, a clarity dialog box 850 is displayed. The dialog box 850 in this example displays different measures of clarity as determined by the system for the identified text. For example, referring to FIG. 8L, the system has determined that the highlighted text 852 has a rating of 4 stars for clarity, which is displayed with three subcomponents: a middle rating for emotion, a more positive rating for tone, and a more passive rating. Turning to FIG. 8M, the user may select one of the subcomponents to learn further about that portion of the analysis. For example, by selecting the emotions subcomponent in FIG. 8M, a search function 860 is displayed. Selecting the search function 860 allows the user to highlight 862 one or more words identified as being associated with the emotion subcomponent. In some cases a subcomponent display 864 may be provided that displays additional information for the user, such as similar words associated with lower and higher emotions as shown in FIG. 8N.

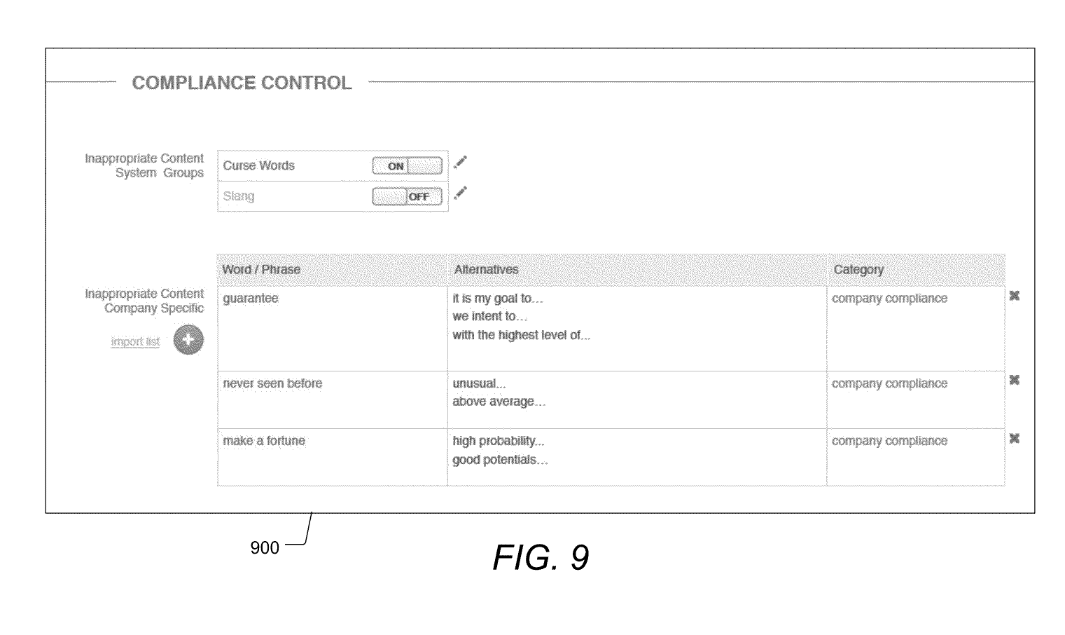

FIG. 9 is a depiction of a system compliance control interface 900 that can be part of the system. In this example the compliance control interface 900 allows a user to customize certain criteria used in the message analysis by the system. For example, the user may select buttons to analyze for curse words and/or slang. In addition, the user may add specific words or phrases (e.g., one at a time, importing an entire list, etc.) that should always be identified by the system as inappropriate content. As shown in FIG. 9, the user may also enter possible alternative text that can be displayed to a message author during message composition.

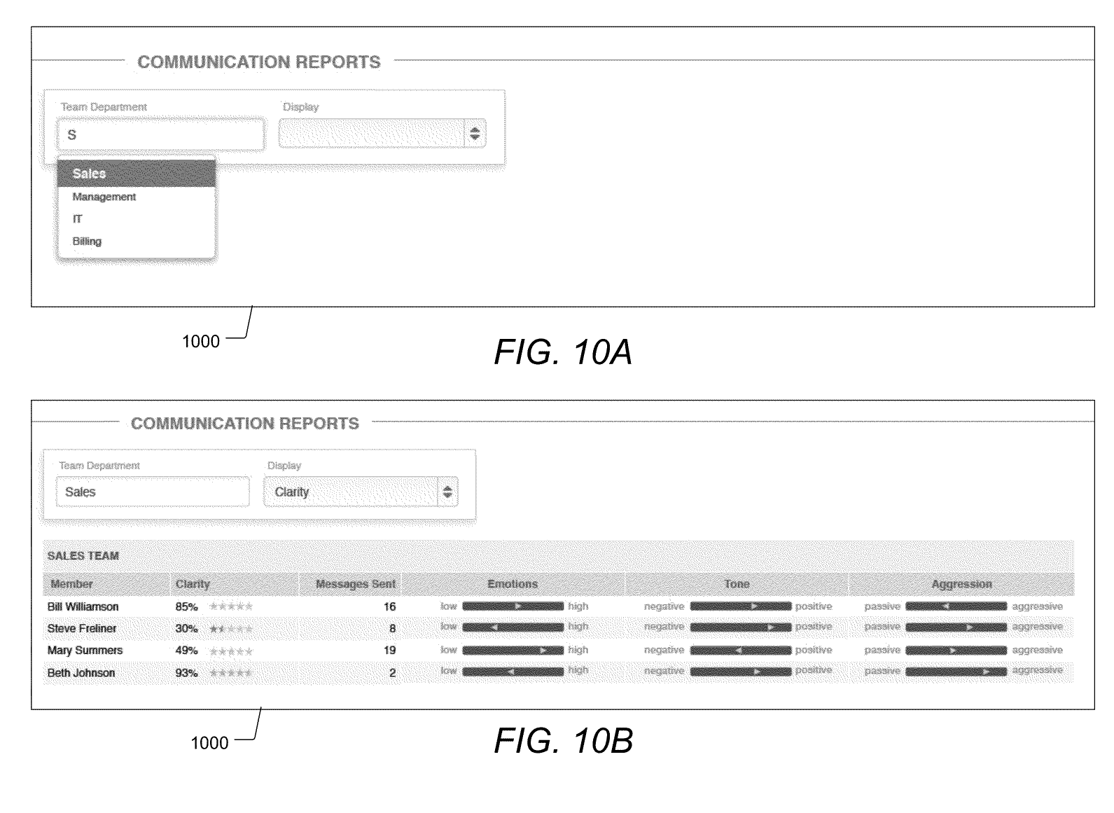

FIGS. 10A and 10B are depictions of a communications reports interface 1000 that the system can include. The communications reports interface 1000, as well as the compliance control interface 900 and other controls, may in some cases be accessible only through an administrative log in. The communications reports interface 1000 shown in FIGS. 10A-10B allows a user to select different company departments, and then display a summary of analyses performed on messages sent by members of a particular department.

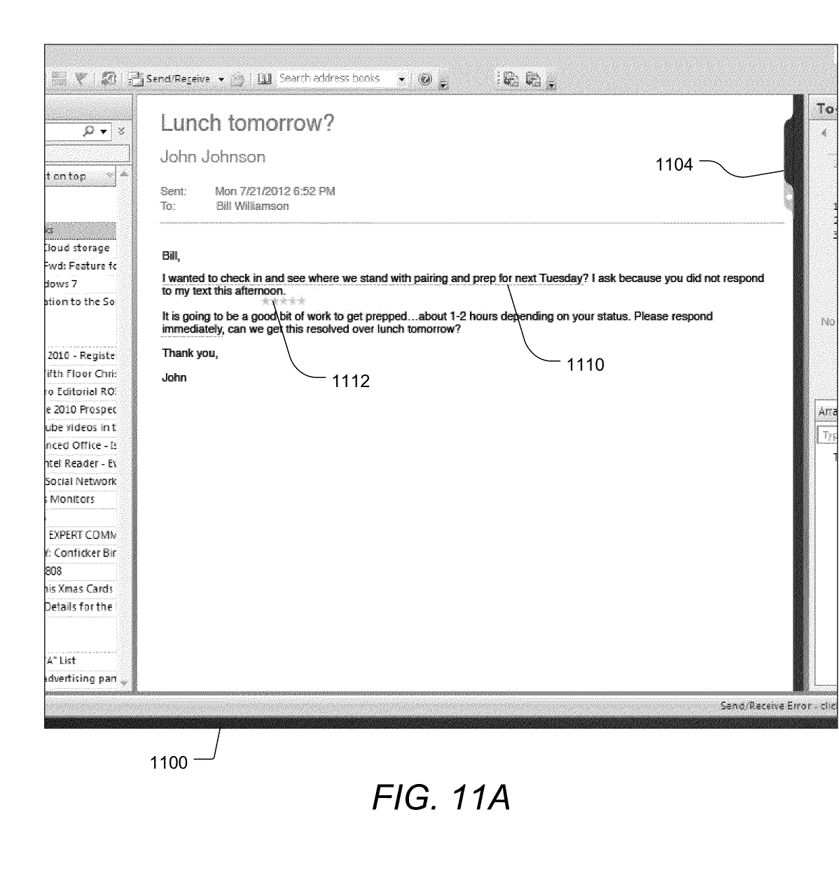

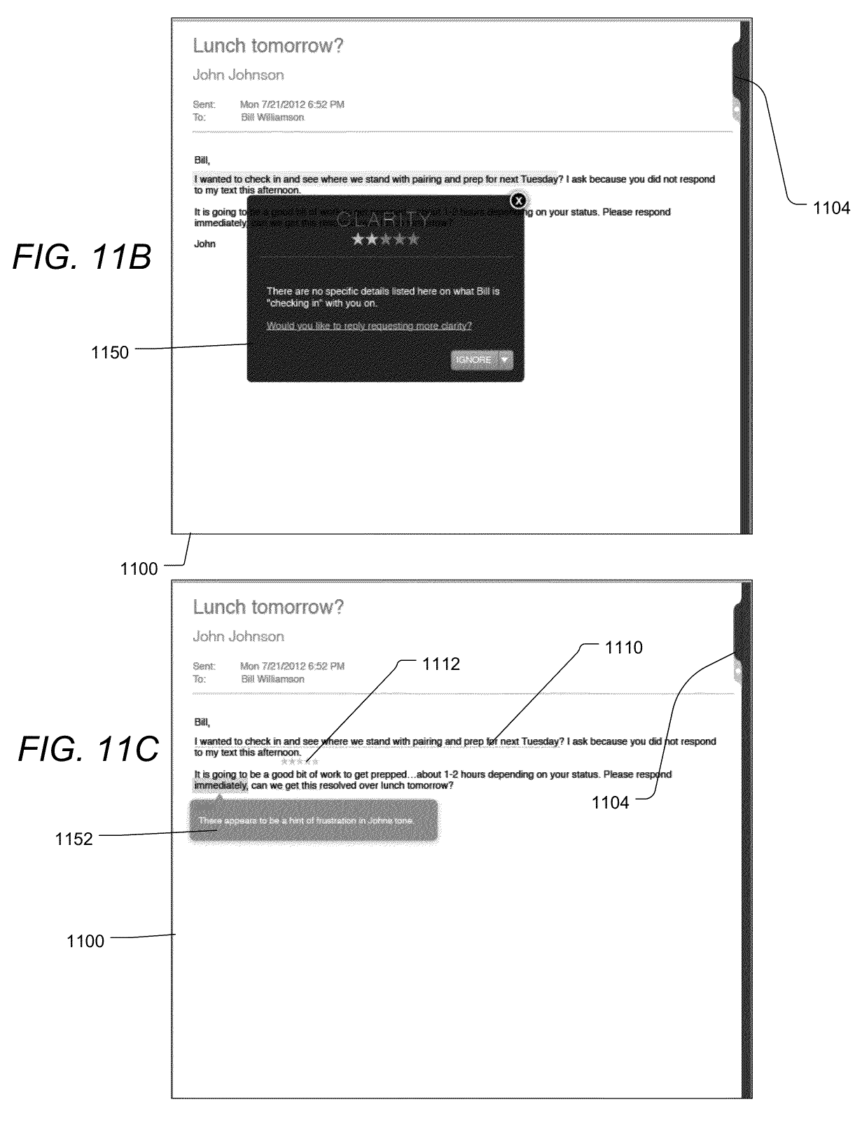

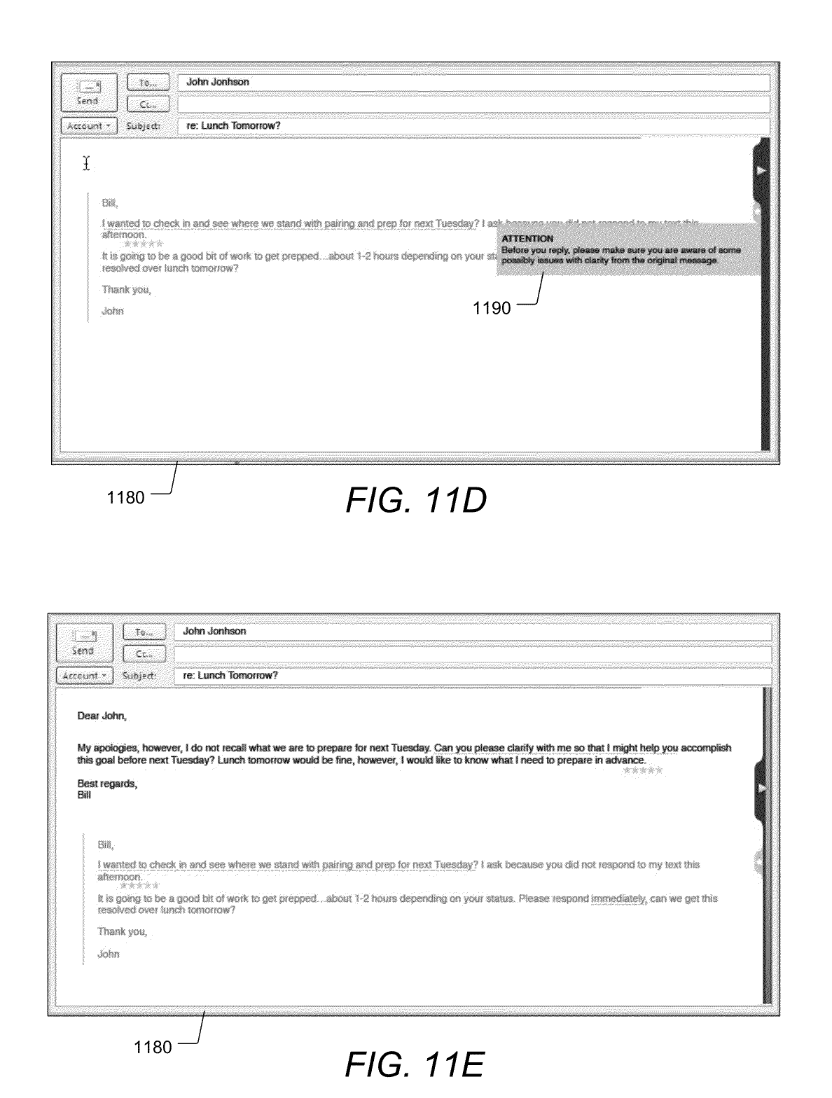

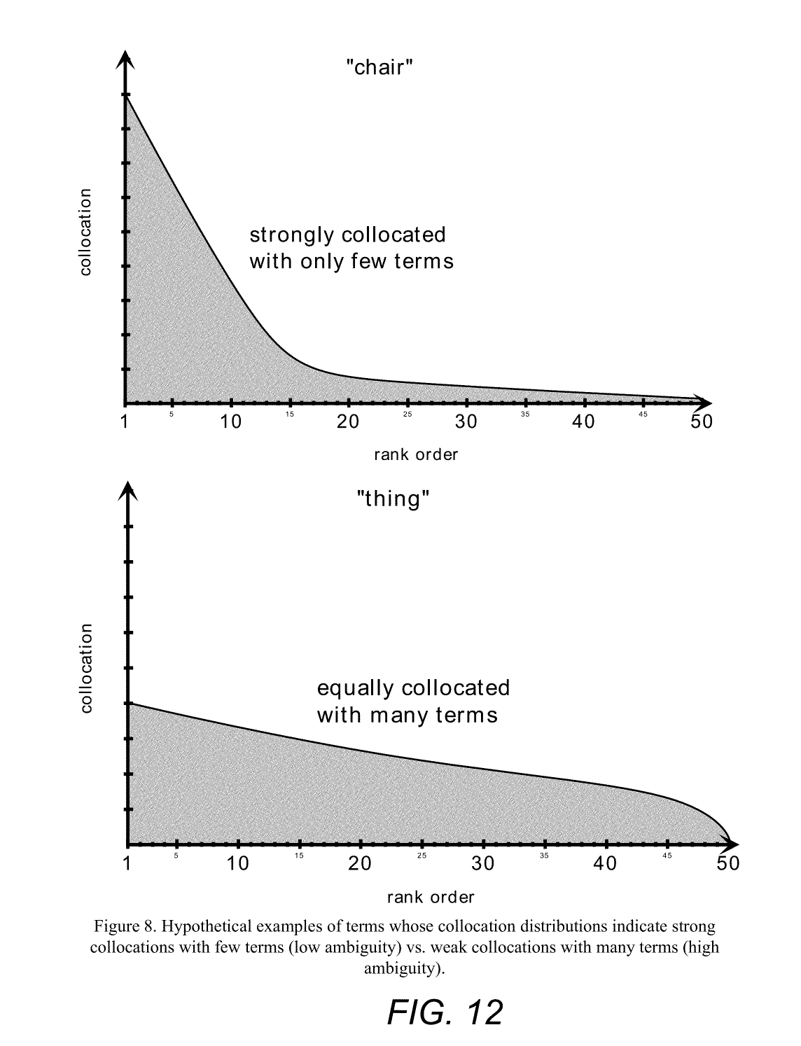

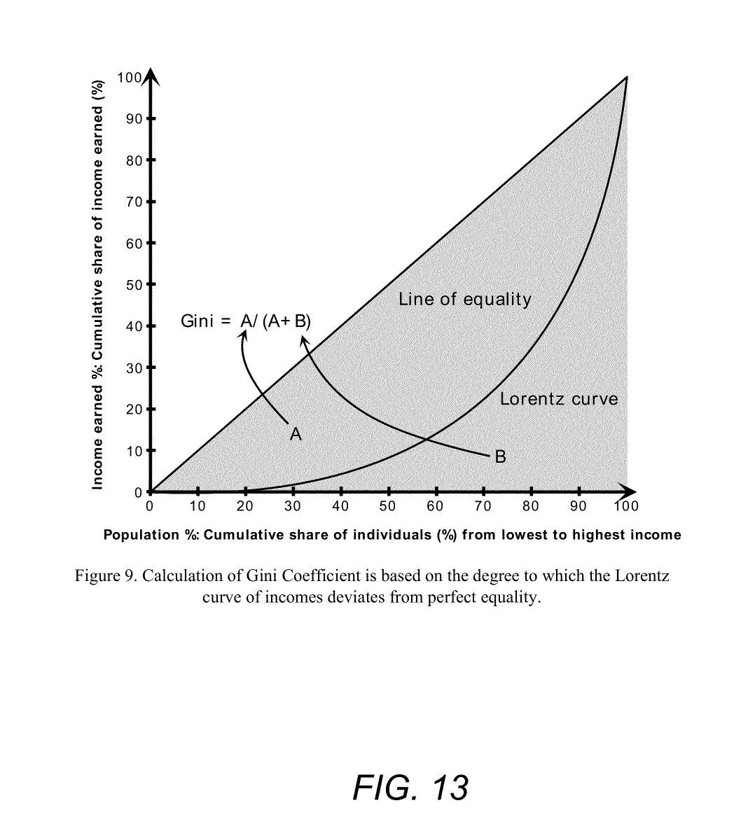

FIGS. 11A-11C illustrate an example of a message reading pane 1100 in which a message recipient can review a message (in this case an email) with the assistance of a textual analysis provided by the system. In some cases the capabilities of the system within the reading pane 1100 may be similar to the functions and features provided within the message composition window 802. For example, the system may display within the reading pane 1100 a sliding bar indicator status indicator 1104 (e.g., optionally indicating the overall determined clarity of the received message), underlining 1110, star ratings 1112, and a clarity dialog box 1150. In addition, in some cases the system may provide a visual display 1152 of possible emotions within the message that the system has identified during the analysis.

Turning to FIGS. 11D-11E, in the case that a user decides to reply to a message, a reply composition window 1180 can be displayed. In this case, the system can analyze the text of the user's reply message in a manner similar to that described above with respect to FIGS. 8A-8Q. In some cases, the system may also provide a reminder to the replying author that he or she should keep in mind possible ambiguities within the original message. In the example shown in FIGS. 11D-11E, an attention dialog 1190 can be displayed to remind the user to review the system's analysis of the original message to which the user is replying.

As discussed above, embodiments described herein review digital communications, including written, and in some cases digital representations of oral communications, using one or more analysis methods and/or criteria. As a broad overview, systems and/or methods may analyze digital communications and/or digital documents in order to identify and possibly extract unclear, subjective, ambiguous or definitive words, terms, phrases, references, inferences, and other component of the lexicon, along with their antecedents. This can be achieved in a number of ways. A number of examples of analysis methods and criteria that are used and/or can be used in some embodiments will now be described.

Some embodiments analyze on or more aspects of a digital text and then provide feedback in the form of a characterization of the text based on the analysis. Any number of possible aspects of a digital document/text may be analyzed as should be appreciated. The following non-limiting examples provide illustrations of analyzing digital documents in relation to the ambiguity and/or clarity of the text of the document.

According to some embodiments, a system and/or method can analyze clarity and/or ambiguity of a digital text by decomposing the text (e.g., a sentence) into terms, which in some cases may each be “part-of-speech”(POS)-tagged (lexical classification) by an off-the-shelf POS-tagger, such as Stanford POS Parser. For each document term, a distribution of the term may be determined and/or generated based on occurrences of the document term within a text sample and occurrences of sample terms within the text sample. In some cases this includes a degree of co-location and/or co-occurrence between the term in question and all other terms it is commonly associated within the text sample. According to some cases the distribution can be computed using Pearson or Spearman correlation cosine similarity, Pointwise Mutual Information, and/or a variety of other distance or similarity measures.

According to some embodiments, the shape of the document term distributions (e.g., co-location and/or co-occurrence distributions) with which a term is related to all other terms indicates the degree to which the term is generally associated with different meanings and contexts. The distribution of these degrees of association is unique to each term and various characterizations of the distribution can provide further information about the document term. In some cases the “inequality” of the distribution tells us whether a term has a more limited, precise meaning related to only a few particular terms, or a more general meaning related to very many other terms and contexts in the language. In some cases a distribution characteristic, an inequality index, and/or other measure of variance in the distribution of one or more document terms can be determined according to a variety of measures. Examples include, but are not limited to a distribution's scaling exponent, an estimated exponent of rank-ordered distribution terms, a y-intersect of an exponential function fitted to rank-ordered distribution terms, a Gini coefficient of a distribution of each document term, an entropy of a distribution of each document term, and/or one of these or another measure of the distribution calculated for a particular sub-sample of terms.

According to some embodiments, the distribution characterization may be associated with an ambiguity of the document term. The ambiguity or clarity of a sentence can then be measured as the aggregate of its term ambiguities. Weights can be defined on the basis of POS tagging, so that for example verbs and nouns have higher weights in the calculation of aggregate sentence ambiguity than pro-nouns and articles.

The same calculation can be developed and performed not just for individual terms, but for groups of terms in the communication. For example, in some cases a system can calculate ambiguity for grouped co-locations as derived from natural language data sources such as email archives, social media feeds, and other available resources.

Systems and/or methods according to some embodiments can also or instead analyze digital communications in order to identify and extract language-specific grammatical variances such as formality, tense, colloquialisms, and tone of digital written and/or oral communications.

In some cases a system may accomplish this by leveraging crowd-sourcing methods to classify a wide range of terms or groups of terms as formal vs. informal. Once an adequate level of inter-rater agreement has been achieved, the system may train a classifier to recognize features associated with formality, e.g. “Mr.”, “yours sincerely”, etc. When applied to a specific communication the classifier will yield a classification according to the communication's tone or formality. Examples of classifiers can include Naive Bayesian classifiers, Support Vector Machines, Neural networks, Decision tree learning, and linear regression.

In some cases a system and/or method may tag and classify the source material to identify parts of speech and speech patterns to be used in intent and clarity analysis. In some cases this can be achieved using widely available Part of Speech Taggers which will tag each word in a sentence with its lexical classification and can perform entity and predicate extraction. Some possible examples of POS taggers include, but are not limited to, NLTK and Stanford POS tagger. NLTK (http://nitk.org/) is available in a variety of computer language and idioms, including Python and Java. Stanford POS tagger can work out the grammatical structure of a sentence, supporting the identification of subject, predicates, and objects, which can be leveraged in this and other analyses, in particular those oriented towards the detection of intent towards a particular subject.

A comparison of tagged sources and extractions to the lexicon can be carried out and material can be classified based on values in the lexicon. In some cases, values in the lexicon can comprise a variety of indicators, such as but not limited to:
1) Sentiment values extracted from various databases, including sentiment databases. Some possible examples of sentiment databases include, but are not limited to, Sentiwordnet, ANEW, OpinionFinder, etc.;
2) Sentiment values created by means of crowd-sourcing, e.g. Amazon's Mechanical Turk;
3) grammatical and lexical categories that are produced by Part-of-Speech taggers;
4) thesauri;
5) term frequency tables; and
6) term ambiguity values calculated from data previously analyzed by a system in accordance with an embodiment.

On the basis of those data, in some cases each term and sentence can be assigned a feature vector. Similarity values can be calculated for any grouping of terms on the basis of similarities or dissimilarities in their feature vectors. The resulting matrices of similarities can be subjected to classification and clustering methods using standard machine learning tools such as for example Naïve Bayesian classifiers, Support Vector Machines, Decision trees, hierarchical clustering, k-means clustering, Principal Component Analysis, Latent Semantic Indexing, and Latent Dirichlet Allocation. Unsupervised machine learning techniques can be used to conduct a post hoc analysis of users' or user community's email archives to determine desirable criteria or thresholds for classifying future communications as either exceeding or not meeting established communication patterns typical or desirable for that user or community.

According to some embodiments, one or more scoring mechanisms may define degrees of clarity, formality, and tone and/or may define criticality of communication deviations from the lexicon. In some cases criticality of communication deviations can be an indication of how serious or important the deviation may be, and/or an estimate of how much attention an author should devote to a particular deviation depending upon the context of the communication (e.g., personal vs. business) and nature of the deviation (e.g., using words that are not merely confusing but perhaps unknowingly taboo).

According to some embodiments, methods and systems utilize computer-based algorithms derived from artificial intelligence, machine learning, or other extant technologies to build an analysis, suggestion, and response software. Systems using AI and machine learning will continuously and dynamically enhance the capabilities of the product. In some embodiments the computer-based algorithms may be derived from new technology. A presentation format for results may be developed to dynamically display classifications and/or analysis to the author throughout communication composition.

Artificial Intelligence is the sprawling science concerned with the development of machine intelligence. More colloquially put, AI seeks to develop algorithms, heuristics, and even hardware that endows computers with behavior and capabilities that we generally associate with human or animal intelligence, such as perception of its environment, learning, knowledge acquisition, object, image and speech recognition, logic, reasoning, inference, ability to spatially manipulate objects, interact socially, adapt to changing environments, problem solving, and planning one's own actions and behaviors.

Some embodiments of the invention can use artificial intelligence techniques mostly in the area of machine learning for classification and recognition, i.e., classification algorithms and heuristics that are trained to discover regularities in linguistic data sets, e.g., “Is this expression very formal?” and respond accordingly with a desired level of accuracy, e.g., “Yes, with a likelihood of 80%.”

Machine learning algorithms can take many forms. Some are supervised, i.e., they must first be shown which answers are correct or not in a large training set, and will from that training set learn to recognize the features that are associated with correct or incorrect answers. Some embodiments of the invention may use supervised machine learning algorithms mainly for classification, i.e., training data will be obtained from standardized, tagged collections of text data obtained from the web or other sources and will be used to train the algorithm to recognize features associated with particular emotions, tone, formality, and ambiguity. Typical examples of supervised machine learning algorithms include Naive Bayesian classifiers, Support Vector machines and Decision trees.

Unsupervised learning algorithms do not rely on training sets, but independently discover regularities in training sets which they can then leverage to classify or position new data points. These algorithms and heuristics often rely on optimization heuristics that gradually adjust groupings or organizations of the data to achieve certain pre-determined global or local criteria. Some embodiments can make use of these algorithms mainly in the area of providing useful user feedback by making recommendations on the basis of clustering results and dimensionality reduction results that reveal the underlying dimensions along which messages, words, expressions, n-grams, and other features are related.

In addition, machine learning algorithms may allow embodiments of the systems and/or methods to respond dynamically to changes in language, e.g., new trends in colloquial language, culture, user habits, and user feedback.

According to some embodiments, a system for analyzing digital language for ambiguities includes a user interface that allows an author to interact with the system. The user interface (UI) facilitates interpretation by the author of ongoing communication analysis. In some cases a UI may provide live and dynamic writing feedback that is unintrusive, pleasant, yet informative, potentially inspired by bio-feedback approaches in which individuals receive otherwise hidden information about their behavioral or mental states and can leverage that to better control undesirable outcomes and achieve better productivity and well-being.

In some cases the UI may notify the author of identified content of any communication(s) where revision(s) may be needed. In some embodiments the UI may incorporate a dynamic gradient to monitor and display degree of criticality for reconsideration by the author. In further embodiments the dynamic gradient or display monitor may incorporate a readily recognizable analogy or theme to aid in its interpretation (e.g., a stop light monitor—go/caution/stop, green/yellow/red). In some cases a system may further notify communications recipients of implied intent in a clear, unambiguous, actionable manner. Interfaces may include recommendation systems based on term and n-gram similarities to propose alternate, improved formulations for greater clarity and more appropriate tone.

According to some embodiments, analysis of digital communications for ambiguity, clarity, tone, and other characteristics may be based on a foundational analysis of language usage tendencies. For example, in some cases a system according to an embodiment may analyze thousands of existing digital communications to establish a baseline of linguistic connotation versus denotation, grammatical inference and contextual cues. This data will be utilized to establish criticality factors for clarity and the resulting scoring system and mechanisms. According to some embodiments, a variety of data sources, e.g., email archives, social media feeds etc., each suitable for a particular field of use, e.g., business emails vs. personal social media communication, can be used to produce normed training sets for automated classifiers. This can be helpful in the area of ambiguity and formality recognition, as well as the recognition of colloquial forms that may not be fully reflected in existing linguistic corpora.

In some embodiments, a system and/or method for analyzing digital communications for the presence of, e.g., ambiguities, provides certain advantages and increased functionality over other forms of language analysis currently available. As one example, spelling and grammar checks currently available in word processing programs such as Microsoft Word typically work on specifically defined rules within the hierarchy of language. For spelling check, words are either spelled correctly or incorrectly, and for grammar check the analysis extends to suggest whether words and phrases are used correctly within the sentence structure. However, it is quite limited in the granularity of its analysis. For example, in the sentence “The boys wanted to take there books to one schools,” we note the word “there” is spelled correctly, but is still underlined in blue as, grammatically, it should be corrected to read “their.” However, spell and grammar check do not detect the change in plurality of “one schools” in this example.

Some embodiments of the invention provide solutions to different and in some cases far more complex challenges. The “intent” or “point of view” of a communication comprises numerous subjective components of the lexicon—clarity, directness, and ambiguity, to name a few. Some embodiments will question and analyze complex communications in order to correctly interpret examples such as the classic, “Did she see the Venetian blind?” or “Did she see the blind Venetian?”

According to some embodiments, systems and/or methods for analyzing digital language such as in communications, documents, etc., incorporate the use of n-gram word collocation analysis. An n-gram is a series of n words appearing in a specific order, for example “The Quick Brown Fox” is a frequent 4-gram in the English language, but “gobbledegook gefilte beef” is a much less common 3-gram. As is known, very large-scale n-gram databases exists in the public domain which provide data on the occurrence of specific word collocations over a large sample of all online texts, in some cases retrieved and analyzed by search engines from their crawls of the entire web. (See, for example, http://googleresearch.blogspot.com/2006/08/all-our-n-gram-are-belong-to-you.html, and http://www.ldc.upenn.edu/Catalog/catalogEntry.jsp?catalogId=LDC2009T25.) In some instances more than a billion tokens of running text have been analyzed to extract all possible sequences of n words appearing in a given order. N-gram data can be used to determine how frequently words are used in sequence with others or in proximity to others. This allows search engines to pro-actively real-time suggested completions of user search queries by looking up the most likely completions in their databases of n-grams. For example, when a user enters “Microsoft”, the system might look up the most frequently occurring 2- or 3-grams that start with that word, and offer the user to complete the query with its most likely associate, namely “Word” or “Word question.”

In some cases systems and/or methods in accordance with some embodiments of the invention analyze how often various words are used together in proximity or sequence, to develop a scoring mechanism to determine clarity, subjectivity, or ambiguity. If a word is rarely or NEVER used in combination with other words, then it is considered very clear and unambiguous in meaning. If a word or phrase is OFTEN used in combination with numerous other words and/or phrases, then it can be considered to have multiple meanings, to be subjective, or unclear; and the more often this occurs, its ambiguity grows exponentially. These words and phrases can be scored accordingly, and an analysis of any text can yield an “ambiguity” or “clarity” factor.

A visual metaphor to provide a framework for the understanding of the examiner would be a multi-dimensional cube whose axes corresponds to specific dimensions along which texts can be scored according to specific words, regulatory constraints, kinds of words, policy rules, etc.), deliverable (i.e. clarity, subjectivity, ambiguity, etc.), and/or subset of the deliverable (i.e. valence, arousal, dominance, etc.). (This metaphor is particularly tenable for this explanation as most experts/scientists will understand and appreciate it.)

When a text is scored along the mentioned features, its scores can be used as coordinates to position the text within specific sections of this cube. As the text is updated, its various scores change and thus its position in the cube. This can happen independently for each particular scoring feature or dimension. For instance, the aggregate score for clarity of the message might steadily improve; however, the tone might become increasingly negative. As a result the text will move from one area of the cube to the next, following a path or trajectory through the “cube” space; a system can therefore analyze the text's particular position at a given point in the text, but also the general dynamics of “how” it moves through that space; i.e. the features of its trajectory as the author writes it and adds new words and expressions. Is its movement jerky or smooth? Is it presently deviating from its own “sub-cube?”, e.g. the general tone set by the previous text or a pre-defined criteria such as high clarity and high formality.

One embodiment of the invention may combine this functionality with that of completing the analysis during digital message composition, in order to warn the message author that his/her message includes objectionable, ambiguous or unclear lexicon components, and is subject to misinterpretation or flagging.

An example of a result of our initial proof of concept included the following analysis of a common message:

Love(0.402) the(0.605) analogy(−0.476) to(0.76) Translate(−0.01) and(0.596) I(0.755) believe(0.567) that(0.703) is(0.725) a(0.551) good(−0.111) test(−0.137) mechanism(−0.248) and(0.596) proof(−0.171) of(0.687) concept(0.454) but(0.693) any(−0.091) further(−0.043) thoughts(−0.17) as(0.723) to(0.76) whether(0.59) that(0.703) will(0.669) suffice(0.0) as(0.723) the(0.605) prototype(0.0) to(0.76) show(0.409) potential(−0.05) customers(−0.038) future(−0.068) investors(−0.01) 1(0.755) am(0.434) wondering(−0.309) whether(0.59) people(0.415) will(0.669) immediately(−0.054) say(0.576) is(0.725) nice(−0.048) but(0.693) 1(0.755) need(0.601) to(0.76) see(0.566) how(0.581) it(0.803) works(0.416) in(0.745) a(0.551) practical(−0.03) manner(0.403) in(0.745) something(0.419) 1(0.755) am(0.434) likely(0.725) to(0.76) use(0.694) every(−0.099) We(0.655) are(0.387) going(0.787) to(0.76) need(0.601) that(0.703) a ha(0.0) moment(0.393).

A standard corpus of English language, freely available from the web, was utilized to record the rates at which each word in that corpus was followed by any other word, resulting in about 455,279 bi-grams. According to some embodiments, any suitable corpus of the English language (or other language, depending upon the language being utilized) may be used to analyze and record the rates at which particular words are followed by other words. Just a few examples of possible corpuses that could be used include, but are not necessarily limited to, the Brown corpus, The Corpus of Contemporary American English, and the International Corpus of English.

A segment of a common e-mail was utilized. For each word in the email we determined the frequency distribution of the words, as associated within the corpus. As an example, the analysis may find that the word “chair” is collocated with the following other words in the corpus, according to the frequencies listed below:

and 14
he 3
in 3
the 3
as 2
beside 2
creaked 2
on 2
that 2
was 2
well 2

In other words, “chair” was collocated with the word “and” 14 times in the corpus. The collection of frequencies of collocation or co-occurrence between a given word A and all other words in the corpus thus form the frequency distribution of word A.

Next, a measure of this frequency distribution is calculated to determine how “equally” or “unequally” the given word is associated with a range of other words in the language. FIG. 12. illustrates a hypothetical example of the terms “chair” and “thing” whose collocation distributions indicate strong collocations with few terms (low ambiguity) vs. weak collocations with many terms (high ambiguity). The inequality of the term's co-occurrence or collocation distribution can be measured by a variety of indicators such as Shannon's Entropy, the distribution's scaling exponent, or various measures of inequality.

One form of this, referred to as the Gini Coefficient, is frequently used in economics to describe income inequality: one graphs Lorentz curve as the x % proportion of the total income (%) earned by the x % lowest earners. Total income equality means that for all values of x the two quantities are exactly equal, in other words the bottom x % of earners always represents x % of all income earned, and vice versa. In this situation everybody earns exactly the same and the Lorentz curve is a straight line that runs at 45 degrees. The latter is often referred to as the “line of equality”. This coefficient is defined as the ratio of the surface area below the actual Lorentz curve for a given population vs. the surface area below the “line of equality” as shown in FIG. 13. As an example, the Gini coefficient ranges between [0,1].

Similarly we can calculate measures of inequality of term collocation distributions to determine the degree to which the distribution of the share of the collocation weights of rank-ordered terms matches their contribution to the total frequency of the term they are collocated with. The Gini Coefficient of the collocation or co-occurrence curve then expresses the degree to which a particular term in a communication is associated with a well-defined (unequal) set of other terms and is thus less ambiguous than a term in the same communication whose collocation or co-occurrence curve has a lower Gini coefficient.

Note how very frequent and non-specific words have higher Gini coefficients. More specific words have lower Gini coefficients. These values can be averaged over sections of the sentence or the entire message, with the scores aggregated to provide feedback to the user.

Following are a few possible examples of sentences that can be considered to be “vague” or “clear” based on a predetermined scoring criteria. The sentences were found on Yahoo Answers (one of the features of the Yahoo web portal).

“I need some stuff for school”: I(0.755) need(0.601) some(0.469) stuff(−0.069) for(0.609) school(0.386). *** Average: 0.458: VAGUE

“I need an atlas for my geography lessons.”: 1(0.755) need(0.601) an(0.34) atlas(−0.111) for(0.609) my(-0.122) geography(0.0) lessons(−0.033). *** Average: 0.226: CLEAR

“Have you got a thing to hold stuff together?”: Have(0.685) you(0.636) got(0.565) thing(0.562) to(0.76) hold(0.373) stuff(−0.069) together(0.386) *** Average: 0.444: VAGUE

“May I have a rubber band to hold my pencils together?” May(0.596) I(0.755) have(0.685) a(0.551) rubber(−0.038) band(−0.126) to(0.76) hold(0.373) my(−0.122) pencils(−0.333) together(0.386) ? *** Average: 0.290: CLEAR

As seen, in all cases the sentences determined to be “vague” according to this scoring example have higher overall Gini values (average). Averaging the values across all words in the sentence, the vague sentences have higher average Gini coefficients and can thus be deemed more vague or ambiguous. We can increase the discriminatory value by ignoring certain word classes (such as “a,” “the,” “an,” etc.). Conversely, we can also increase the discriminatory value by adding certain word classes, such as profanity or definitives (such as “guarantee,” “absolutely,” “perfect,” etc.)

One embodiment of the invention may score individual words and/or phrases of digital communications to provide “point in time” analysis of clarity.

One embodiment of the invention may average scores across sections of a digital communication to provide a measurement of clarity in those sections of the message.

One embodiment of the invention may average scores across the entire digital communication to measure clarity of the entire message.

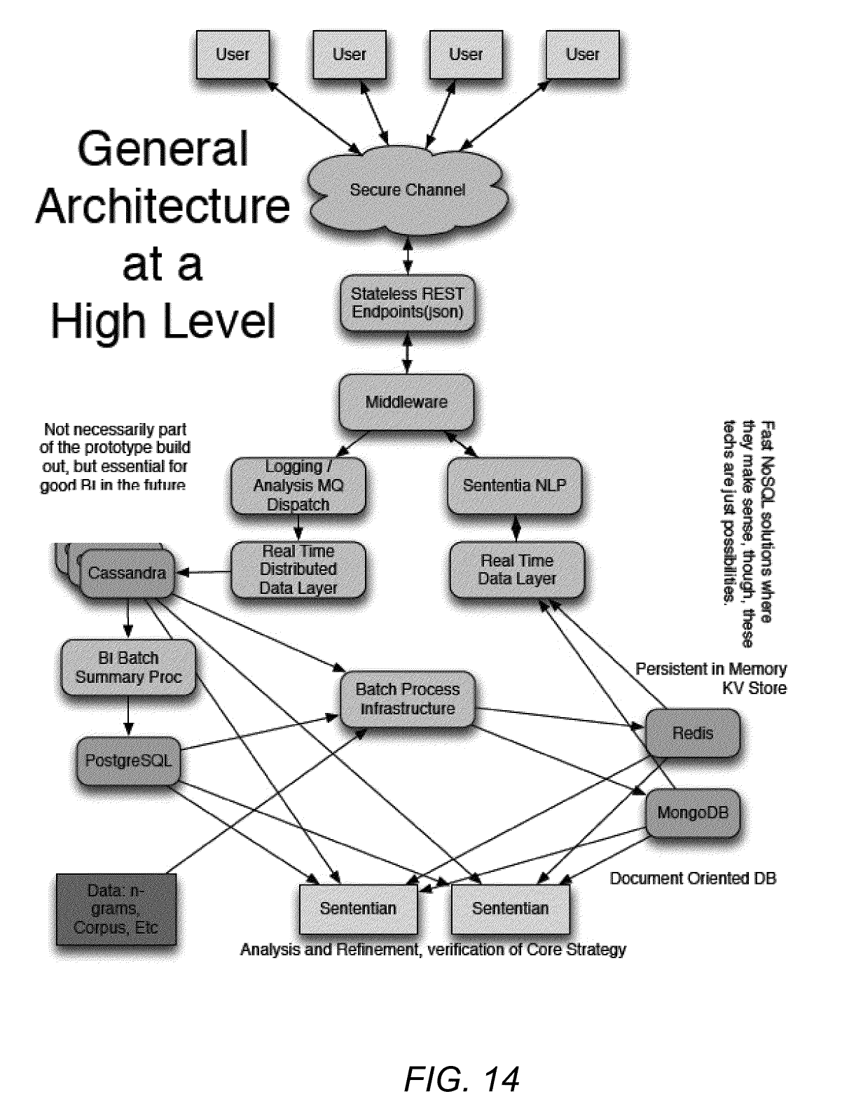

FIG. 14 illustrates one possible example of a general architecture for a system for analyzing clarity and ambiguity in digital communications according to some embodiments.

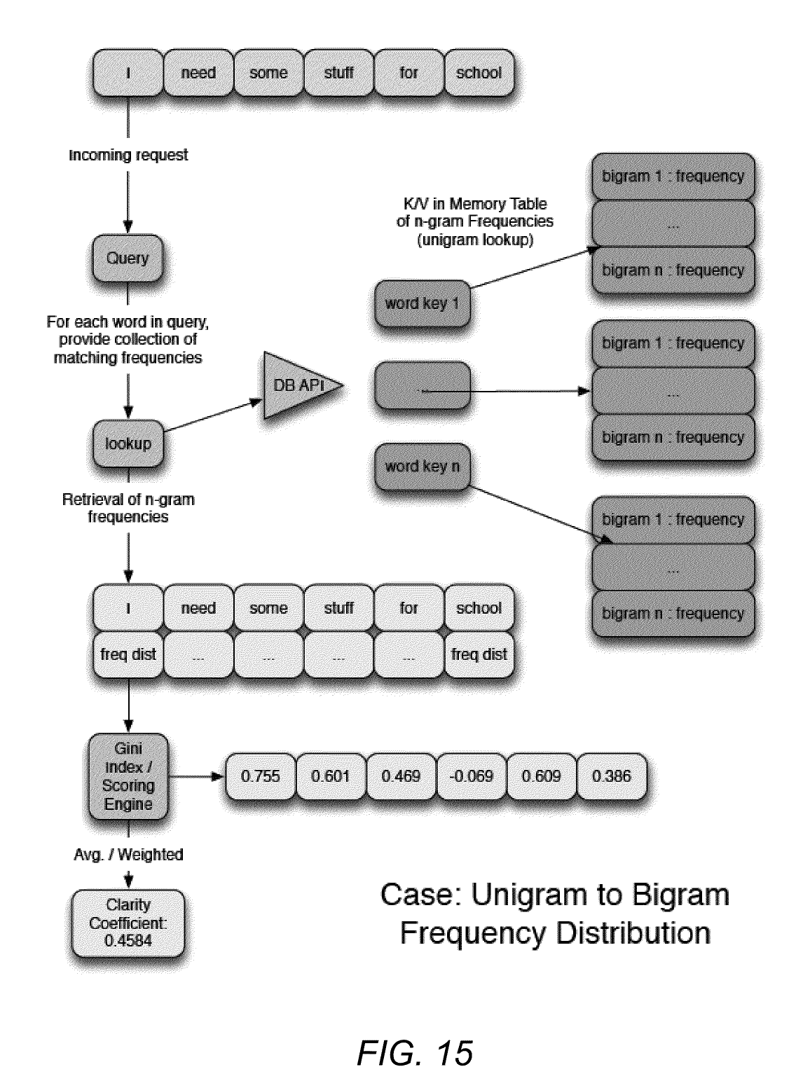

FIG. 15 illustrates one possible case example, among many, of a unigram to bigram frequency distribution analysis according to some embodiments.

Thus, embodiments of the invention are disclosed. Although the present invention has been described in considerable detail with reference to certain disclosed embodiments, the disclosed embodiments are presented for purposes of illustration and not limitation and other embodiments of the invention are possible. One skilled in the art will appreciate that various changes, adaptations, and modifications may be made without departing from the spirit of the invention and the scope of the appended claims.

What is claimed is:

1. A method for analyzing a digital document, comprising:
receiving and/or generating a digital document with processing circuitry, the digital document comprising a text comprising a plurality of document terms;
determining, with the processing circuitry, a distribution of each of the plurality of document terms based on occurrences of the document terms within a text sample and occurrences of sample terms within the text sample;
determining, with the processing circuitry, a distribution characteristic for each of the plurality of document terms, the distribution characteristic for each document term providing a measure of a characteristic of each respective document term's distribution; and
providing a characterization of the text in the digital document with the processing circuitry based on the distribution characteristic of at least one of the plurality of document terms.

2. The method of claim 1, wherein determining the distribution comprises determining, with the processing circuitry, a co-occurrence distribution for each of the document terms with respect to the sample terms within the text sample.

3. The method of claim 1, wherein determining the distribution comprises determining, with the processing circuitry, a co-location distribution for each of the document terms with respect to the sample terms within the text sample.

4. The method of claim 1, wherein determining the distribution characteristic of each of the plurality of document terms comprises determining, with the processing circuitry, an inequality index for each of the document terms based on the distribution of each respective document term.

5. The method of claim 4, wherein determining the inequality index for each of the document terms comprises determining, with the processing circuitry, occurrences of the sample terms within the sample text corresponding to each of the document terms.

6. The method of claim 4, wherein determining the inequality index for each of the document terms comprises determining, with the processing circuitry, Gini coefficients for the sample terms within the sample text corresponding to each of the document terms.

7. The method of claim 1, wherein the characterization of the text in the digital document is based on one or more text characterization factors, and further comprising determining, with the processing circuitry, a first factor corresponding to a first aspect of the text of the digital document.

8. The method of claim 7, further comprising computing the first factor with the processing circuitry based on the distribution characteristic of at least one of the document terms.

9. The method of claim 8, wherein the first factor comprises an ambiguity score and the first aspect of the text comprises ambiguity and/or clarity of the text in the digital document.

10. The method of claim 7, wherein the first aspect of the text comprises compliance with a predetermined criteria, and wherein determining the first factor comprises comparing the plurality of document terms to a word list.

11. The method of claim 7, wherein the first aspect of the text comprises part of speech, and wherein determining the first factor comprises determining a part of speech tag for each of the plurality of document terms.

12. The method of claim 1, wherein providing the characterization of the text comprises providing an indication as to whether the text in the digital document satisfies a predetermined compliance criteria.

13. A system for analyzing digital documents, the system comprising an input module, an output module, and processing circuitry coupled to the input and output modules, the processing circuitry being configured to:
receive a digital document from the input module and/or generate a digital document, the digital document comprising a text comprising a plurality of document terms;
determine a distribution of each of the plurality of document terms based on occurrences of the document terms and occurrences of sample terms within a text sample;
determine a distribution characteristic for each of the plurality of document terms, the distribution characteristic for each document term providing a measure of characteristic of each respective document term's distribution; and
provide a characterization of the text in the digital document based on the distribution characteristic of at least one of the plurality of document terms.

14. The system of claim 13, wherein the processing circuitry comprises at least one processor and at least one non-transitory computer-readable medium storing instructions for configuring the at least one processor to:
receive and/or generate the digital document,
determine the distribution for each of the plurality of document terms,
determine the distribution characteristic for each of the plurality of document terms, and
provide the characterization of the text in the digital document.

15. The system of claim 13, wherein the processing circuitry is further configured to determine the distribution characteristic of each of the plurality of document terms as an inequality index for each of the document terms based on the distribution of each respective document term.

16. The system of claim 13, wherein the characterization of the text in the digital document is based on one or more text characterization factors corresponding to respective aspects of the text of the digital document, and wherein the processing circuitry is further configured to determine a first factor corresponding to a first aspect of the text of the digital document.

17. The system of claim 16, wherein the first factor comprises an ambiguity score and the first aspect of the text comprises ambiguity and/or clarity of the text in the digital document, and wherein the processing circuitry is further configured to compute the ambiguity score based on the distribution characteristic of at least one of the document terms.

18. The system of claim 16, wherein the first aspect of the text comprises compliance with a predetermined criteria, and wherein the processing circuitry is further configured to compare the plurality of document terms to a word list.

19. The system of claim 16, wherein the first aspect of the text comprises part of speech, and wherein the processing circuitry is further configured to determine a part of speech tag for each of the plurality of document terms.

20. An electronic communications system for analyzing digital documents, comprising:
an input device configured to receive text of a digital document from an end user of the system;
processing circuitry coupled to the input device; and
an output device coupled to the processing circuitry, the output device configured to transmit and/or display an output from the processing circuitry;
wherein the text of the digital document comprises a plurality of document terms;
wherein the processing circuitry is configured to
receive the text of the digital document from the input device,
analyze the text of the digital document to determine one or more text characterization factors corresponding to respective aspects of the text in the digital document, and
provide a characterization of the text in the digital document to the output device based on the one or more text characterization factors; and
wherein the one or more text characterization factors comprises a first factor corresponding to a first aspect comprising ambiguity and/or clarity of the text in the digital document.

21. The system of claim 20, wherein the processor is further configured to:
determine a distribution of each of the plurality of document terms based on occurrences of the document terms and occurrences of sample terms within a text sample;
determine a distribution characteristic for each of the plurality of document terms, the distribution characteristic for each document term providing a measure of characteristic of each respective document term's distribution; and
wherein the first factor comprises the distribution characteristic for at least one of the plurality of document terms and wherein the first factor corresponds to the ambiguity and/or clarity of the text in the digital document.

22. The system of claim 20, wherein the processing circuitry is configured to analyze portions of the text of the digital document during composition of the text by the end user, and wherein the processing circuitry is configured to provide corresponding characterizations of the portions of the text to the output device during composition of the text.

23. The system of claim 20, wherein the processing circuitry is configured to analyze portions of the text of the digital document during and/or after composition of the text by the end user, and wherein the processing circuitry is configured to provide the characterization of the text to the output device only after composition of the text is completed by the end user.

24. The system of claim 20, wherein the output device comprises an electronic display, and wherein the processing circuitry is further configured to provide the characterization of the text to the end user by changing a format of one or more portions of the text or the digital document and/or generating a text notification for viewing by the end user on the electronic display.
